(19) United States
(12) Patent Application Publication
(10) Pub. No.: US 2025/0071769 A1
(43) Pub. Date: Feb. 27, 2025

(54) METHOD FOR MONITORING PDCCH, ELECTRONIC DEVICE AND COMPUTER-READABLE STORAGE MEDIUM

(71) Applicant: SAMSUNG ELECTRONICS CO., LTD., Suwon-si, Gyeonggi-do (KR)

(72) Inventors: Min WU, Beijing (CN); Feifei SUN, Beijing (CN)

(21) Appl. No.: 18/727,049

(22) PCT Filed: Dec. 8, 2022
(86) PCT No.: PCT/KR2022/019975

§ 371 Date: Jul. 5, 2024

(30) Foreign Application Priority Data
Jan. 7, 2022 (CN) 202210016547.5

(51) Int. Cl. H04W 72/23; H04L 5/00; H04W 76/28

(52) U.S. Cl. CPC H04W 72/23; H04L 5/0053; H04W 76/28

(57) ABSTRACT

The disclosure relates to a 5G or 6G communication system for supporting a higher data transmission rate. Embodiments of the present disclosure provide a method for monitoring PDCCH, an electronic device and a computer-readable storage medium, the method including: receiving configuration information for configuring a time unit for PDCCH monitoring within a first duration included in each period of a PDCCH SS; monitoring PDCCH based on the configuration information. This application embodiment enables the reduction of the number of PDCCH monitoring, thereby achieving power saving for the UE.

### TECHNICAL FIELD

The present application relates to the field of wireless communication technology and, in particular, to a method for monitoring Physical Downlink Control Channel (PDCCH), an electronic device and a computer-readable storage medium.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHZ” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (cMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

Understanding and correctly estimating the channel in an advance wireless communication system between a user equipment (UE) and an gNode B (gNB) is important for efficient and effective wireless communication.

### Solution to Problem

Embodiments of the present disclosure provide a method for monitoring PDCCH, an electronic device and a computer-readable storage medium, the method including: receiving configuration information for configuring a time unit for PDCCH monitoring within a first duration included in each period of a PDCCH SS; monitoring PDCCH based on the configuration information. This application embodiment enables the reduction of the number of PDCCH monitoring, thereby achieving power saving for the UE.

### BRIEF DESCRIPTION OF DRAWINGS

In order to more clearly explain the technical solutions in the embodiments of the present disclosure, the figures required to be used in the description of the embodiments of the present disclosure will be briefly described below.

FIG. 1 is a schematic diagram of an overall structure of a wireless network according to an embodiment of the present disclosure.

FIG. 2A is a schematic diagram of a transmission path according to an embodiment of the present disclosure.

FIG. 2B is a schematic diagram of a reception path according to an embodiment of the present disclosure.

FIG. 3A is a schematic structural diagram of a User Equipment (UE) according to an embodiment of the present disclosure.

FIG. 3B is a schematic structural diagram of a base station according to an embodiment of the present disclosure.

FIG. 4A is a schematic flowchart of a method for monitoring PDCCH according to an embodiment of the present disclosure.

FIG. 4B is a schematic flowchart of another method for monitoring PDCCH according to an embodiment of the present disclosure.

FIG. 5 is a schematic diagram of determining PDCCH slot location through gap according to an embodiment of the present disclosure.

FIG. 6 is a schematic diagram of determining PDCCH slot location through bit map according to an embodiment of the present disclosure.

FIG. 7 is a schematic diagram of adaptively activating additional PDCCH monitoring on consecutive slots for a duration according to an embodiment of the present disclosure.

FIG. 8A is a schematic diagram of adaptively activating PDCCH monitoring for a duration according to an embodiment of the present disclosure.

FIG. 8B is a schematic diagram of adaptively activating remaining PDCCH monitoring within the current period according to an embodiment of the present disclosure.

FIG. 9 is a schematic diagram of adaptively skipping remaining PDCCH monitoring within the current period according to an embodiment of the present disclosure.

FIG. 10 is a schematic diagram of triggering to skip remaining PDCCH monitoring based on a timer according to an embodiment of the present disclosure.

FIG. 11 is a schematic diagram of triggering to skip PDCCH monitoring for a duration based on a timer according to an embodiment of the present disclosure.

FIG. 12 is a schematic diagram of skipping PDCCH monitoring on part of slots within a duration according to an embodiment of the present disclosure.

FIG. 13 is a schematic diagram of WUS associated with PDCCH search space according to an embodiment of the present disclosure.

FIG. 14 is a schematic diagram of WUS indicating whether to activate additional PDCCH monitoring on consecutive slots for a duration according to an embodiment of the present disclosure.

FIG. 15 is a schematic diagram of WUS indicating whether to activate PDCCH monitoring for a duration according to an embodiment of the present disclosure.

FIG. 16 is a schematic structural diagram of an electronic device according to an embodiment of the present disclosure.

### BEST MODE FOR CARRYING OUT THE INVENTION

Embodiments of the present disclosure provide a method for monitoring PDCCH, an electronic device and a computer-readable storage medium, designed to be able to reduce the number of PDCCH monitoring, thereby achieving power saving for UE.

According to an aspect of an embodiment of the present disclosure, there is provided a method for monitoring PDCCH for a UE, including the following steps of:
receiving configuration information for configuring a time unit for PDCCH monitoring within a first duration included in each period of a PDCCH search space (SS);
monitoring PDCCH based on the configuration information.

In an alternative embodiment, the configuration information includes at least one of the following:
gap information indicating the gap of discontinuous time units for PDCCH monitoring within the first duration included in each period of the PDCCH SS;
information indicating the location of a time unit for PDCCH monitoring within a period, which indicating the location of a time unit for PDCCH monitoring in L consecutive time units within a first duration included in each period of the PDCCH SS via a bit map of L bits, wherein L is a positive integer.

According to an aspect of an embodiment of the present disclosure, there is provided a method for monitoring PDCCH for a UE, including the following steps of:
adapting PDCCH monitoring based on indication information and/or predefined events, wherein the indication information is used to indicate to the UE to adapt PDCCH monitoring and the predefined events are used to trigger the UE to adapt PDCCH monitoring;
wherein the step of adapting PDCCH monitoring includes at least one of the following:

activating additional PDCCH monitoring of a first PDCCH SS on consecutive time units for a second duration;
activating PDCCH monitoring of a second PDCCH SS for a third duration; skipping remaining PDCCH monitoring of a third PDCCH SS within the current period;
skipping PDCCH monitoring of a fourth PDCCH SS for a fourth duration;
skipping remaining PDCCH monitoring of a third PDCCH SS within the current period.

In an alternative implementation, the second PDCCH SS and/or the sixth PDCCH SS include a PDCCH SS configured to be in a sleeping mode via radio resource control (RRC) signalling.

In an alternative implementation, the step of activating additional PDCCH monitoring of a first PDCCH SS on consecutive time units for a second duration, activating PDCCH monitoring of a second PDCCH SS for a third duration, or activating remaining PDCCH monitoring of a sixth PDCCH SS within the current period based on indication information and/or predefined events comprises at least one of the following:
activating additional PDCCH monitoring of the first PDCCH SS on consecutive time units for the second duration, activating PDCCH monitoring of the second PDCCH SS for the third duration, activating the remaining PDCCH monitoring of the sixth PDCCH SS within the current period based on the indication of at least one of the received control element of media access control layer (MAC CE), downlink control information (DCI), and an activation signal, where the activation signal is carried by a physical signal sequence;
activating additional PDCCH monitoring of the first PDCCH SS on consecutive time units for the second duration if a DCI for scheduling new transmission is received on the first PDCCH SS;
activating additional PDCCH monitoring of the first PDCCH SS on consecutive time units for the second duration, if a DCI for scheduling new transmission is received on the first PDCCH SS and the DCI comprises at least one of the following: a DCI that scrambles cyclic redundancy check (CRC) with a predefined radio network temporary identity (RNTI) value; a DCI uses a predefined DCI format; a DCI includes information indicating predefined service characteristic; and the transport block size (TBS) scheduled by the DCI is greater than at least one of a predefined threshold;
if a scheduling request (SR) is transmitted, activating additional PDCCH monitoring of the first PDCCH SS associated with the SR on consecutive time units for a second duration after transmitting the SR, or activating PDCCH monitoring of the second PDCCH SS associated with the SR within a third duration after transmitting the SR, or activating remaining PDCCH monitoring of the sixth PDCCH SS associated with the SR after transmitting the SR within the current period;
if a configured grant (CG) PUSCH is transmitted, activating additional PDCCH monitoring of the first PDCCH SS associated with the PUSCH on consecutive time units for a second duration after the PUSCH is transmitted, or activating PDCCH monitoring of the second PDCCH SS associated with the PUSCH for a third duration after the PUSCH is transmitted, or activating remaining PDCCH monitoring of the sixth PDCCH SS associated with the PUSCH within the current period.

In an alternative implementation, the method further includes:
monitoring the activation signal by at least one of the following means:
periodically monitoring the activation signal;
monitoring the activation signal at multiple time domain locations within a fifth duration included in each period of the activation signal.

In an alternative implementation, the step of monitoring the activation signal at multiple time domain locations within a fifth duration included in each period of the activation signal comprises:

if the activation signal is monitored at a time domain location, monitoring the activation signal at other time domain locations after the time domain location where the activation signal was monitored within the same period is skipped.

In an alternative implementation, the step of activating additional PDCCH monitoring of the first PDCCH SS on consecutive time units for the second duration is also to be performed within a non-active time of discontinuous reception (DRX); and/or
the step of activating PDCCH monitoring of the second PDCCH SS for a third duration is also to be performed within the non-active time of DRX; and/or
the step of activating remaining PDCCH monitoring of the sixth PDCCH SS within the current period is also to be performed within the non-active time of DRX.

In an alternative implementation, the step of skipping remaining PDCCH monitoring of a third PDCCH SS within the current period based on indication information and/or predefined events comprises at least one of the following:
skipping remaining PDCCH monitoring of the third PDCCH SS within the current period based on the indication of the received MAC CE or DCI;
skipping remaining PDCCH monitoring of the third PDCCH SS within the current period if no scheduling DCI is received on the third PDCCH SS for the sixth duration.

In an alternative implementation, the length of the sixth duration is configured via a first timer and that if the first timer stops running, the remaining PDCCH monitoring of the third PDCCH SS within the current period is skipped starting at a first time unit after the first timer stops running,
wherein the first timer is started at the start location of each period of the third PDCCH SS;
if a DCI with cell-RNTI (C-RNTI) or configured scheduling-RNTI (CS-RNTI) scrambled CRC is received on the third PDCCH SS, the first timer is started or restarted.

In an alternative implementation, the step of skipping PDCCH monitoring of a fourth PDCCH SS for a fourth duration based on the indication information and/or predefined events comprises at least one of the following:
skipping PDCCH monitoring of the fourth PDCCH SS for the fourth duration if no scheduling DCI is received on the fourth PDCCH SS for the seventh duration;
skipping PDCCH monitoring of the fourth PDCCH SS for the fourth duration based on the indication of the received MAC CE or DCI.

in an alternative implementation, the length of the seventh duration is configured via a second timer and that if the second timer stops running, the PDCCH monitoring of the fourth PDCCH SS for the fourth duration is skipped starting at a first time unit after the second timer stops running;
wherein the second timer is started or restarted if a DCI with C-RNTI or CS-RNTI scrambled CRC is received is received on the fourth PDCCH SS.

In an alternative implementation, the step of skipping PDCCH monitoring of a fourth PDCCH SS for a fourth duration includes:
skipping PDCCH monitoring of the fourth PDCCH SS on part of the time units for the fourth duration.

In an alternative implementation, the step of skipping PDCCH monitoring of the fourth PDCCH SS on part of the time units for the fourth duration includes:
skipping PDCCH monitoring on one time unit every N consecutive time units for the fourth duration, and PDCCH monitoring on the other time units is reserved; or
reserving PDCCH monitoring on one time unit every N consecutive time units for the fourth duration, and PDCCH monitoring on the other time units is reserved;
where N is a positive integer.

In an alternative implementation, the method further includes at least one of the following:
determining the length of a second duration, a third duration or a fourth duration based on the indication of at least one of the received RRC signalling, MAC CE and DCI, wherein the indication granularity of the length of the second duration, the third duration or the fourth duration is a slot;
determining, based on the indication of the received RRC signalling, a plurality of candidate values for the length of the second duration, the third duration or the fourth duration, determining one of the plurality of candidate values as the length of the second duration, the third duration or the fourth duration based on the indication of at least one of the received MAC CE and DCI;
determining the identification number ID of the first PDCCH SS, the second PDCCH SS, the third PDCCH SS, the fourth PDCCH SS, or the sixth PDCCH SS based on the indication of at least one of the received RRC signalling, MAC CE and DCI;
determining a PDCCH SS transmitting MAC CE as the first PDCCH SS, the third PDCCH SS, or the fourth PDCCH SS;
determining a PDCCH SS transmitting DCI as the first PDCCH SS, the third PDCCH SS, or the fourth PDCCH SS,
where the MAC CE and/or DCI includes information to indicate adaptation of PDCCH monitoring.

In an alternative implementation, the step of adapting PDCCH monitoring based on indication information and/or predefined events includes:
starting or skipping PDCCH monitoring of the fifth PDCCH SS within a period based on the indication of at least one of the received MAC CE, DCI and activation signal, wherein the activation signal is carried by a physical signal sequence.

In an alternative implementation, the DCI or activation signal is associated with one period of the fifth PDCCH SS, wherein

the gap between the time domain location of the DCI or activation signal and the start location of its corresponding period is predefined or pre-configured by RRC signalling; and/or
the gap between the start and/or end location of the monitoring span of the DCI or activation signal and the start location of its corresponding period is predefined or pre-configured by RRC signalling.

In an alternative implementation, the first PDCCH SS, the second PDCCH SS, the third PDCCH SS, the fourth PDCCH SS, the fifth PDCCH SS, or the sixth PDCCH SS comprises at least one of the following:
a PDCCH SS;
a group of PDCCH SSs;
all UE-specific search spaces (USSs);
all USSs and Type 3 common search spaces (CSSs);
all USSs and all CSSs.

In an alternative implementation, the DCI includes at least one of the following:
DCI for scheduling data;
dedicated DCI indicating power saving commands;
dedicated DCI for a UE;
dedicated DCI for a group of UEs.

In an alternative implementation, if the DCI is a UE-group specific DCI, the starting location in the DCI of the information bit used to indicate to the UE to adapt PDCCH monitoring is indicated by RRC signalling.

According to another aspect of an embodiment of the present disclosure, there is provided a method for monitoring PDCCH for a base station, including the following steps of:
transmitting indication information and/or configuration information to a UE to cause the UE to perform a corresponding PDCCH monitoring behaviour based on the indication information and/or configuration information, wherein the indication information is used to indicate to the UE to adapt PDCCH monitoring and the configuration information is used to configure a time unit for PDCCH monitoring within a first duration included in each period of a PDCCH SS.

According to a further aspect of the present disclosure, there is provided an electronic device, including:
a transceiver; and
a processor, coupled to the transceiver and configured to perform control to perform the steps of the method for monitoring PDCCH for a UE provided in this application.

According to a further aspect of the present disclosure, there is provided an electronic device, including:
a transceiver; and
a processor, coupled to the transceiver and configured to perform control to perform the steps of the method for monitoring PDCCH for a base station provided in this application.

According to a further aspect of the present disclosure, there is provided a computer-readable storage medium, in which a computer program is stored, characterized in that the computer program when executed by the processor implements the steps of the method for monitoring PDCCH for a UE provided in the present disclosure.

According to a further aspect of the present disclosure, there is provided a computer-readable storage medium, in which a computer program is stored, characterized in that the computer program when executed by the processor implements the steps of the method for monitoring PDCCH for a base station provided in the present disclosure.

According to a further aspect of the present disclosure, there is provided a computer program product comprising a computer program, the computer program when executed by a processor implementing the steps of the method for monitoring PDCCH for a UE provided in the present disclosure.

According to a further aspect of the present disclosure, there is provided a computer program product comprising a computer program, the computer program when executed by a processor implementing the steps of the method for monitoring PDCCH for a base station provided in the present disclosure.

According to the method for monitoring PDCCH, the electronic device and the computer-readable storage medium provided in this application embodiment, configuration information for configuring a time unit for PDCCH monitoring within a first duration included in each period of a PDCCH SS is received, and then, PDCCH is monitored based on the configuration information, which enables the reduction of the number of PDCCH monitoring, thereby achieving power saving for the UE.

### MODE FOR THE INVENTION

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-Long Term Evolution (LTE) systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

Power saving technology has always been an important design objective for communication systems, especially on UE (User Equipment) side. With the development of various businesses, new power saving solutions are yet to be proposed.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Exemplary embodiments of the present disclosure are further described below with reference to the accompanying drawings.

The text and drawings are provided as examples only to help readers understand the present disclosure. They are not intended and should not be understood as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

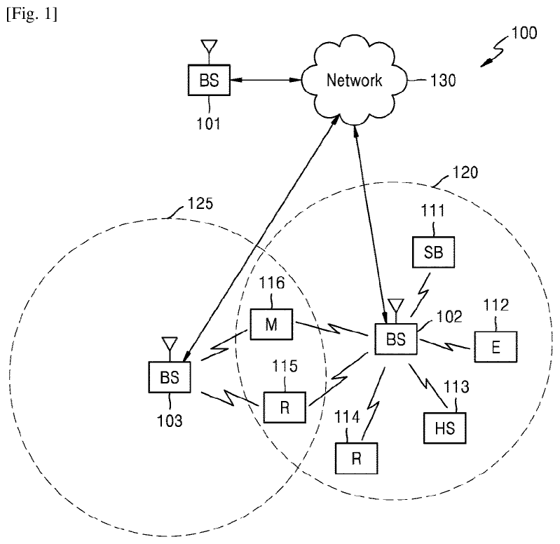

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. GNB 101 communicates with gNB 102 and gNB 103. GNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

GNB 102 provides wireless broadband access to the network 130 for a plurality of first User Equipments (UEs) within a coverage area 120 of gNB 102. The plurality of first UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to the network 130 for a plurality of second UEs within the coverage area 125 of gNB 103. The plurality of second UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

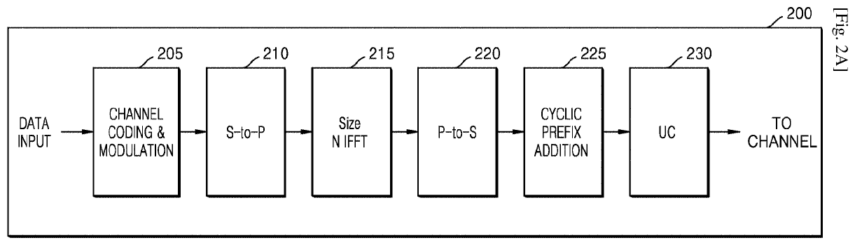

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a group of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be understood as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

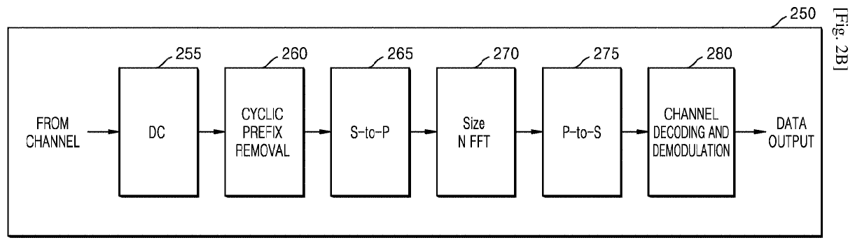

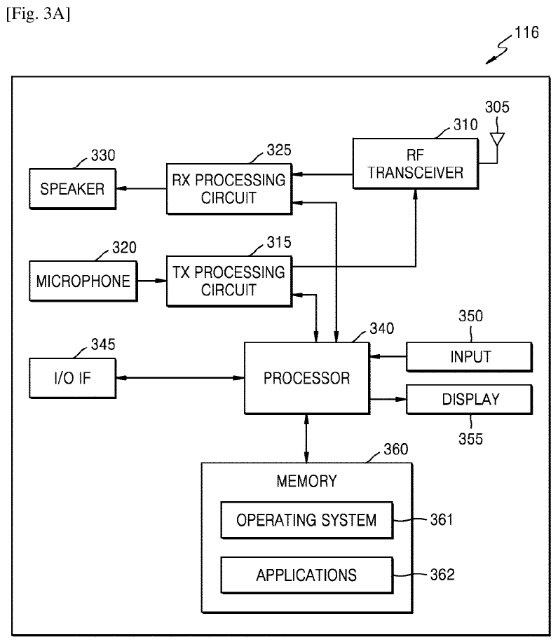

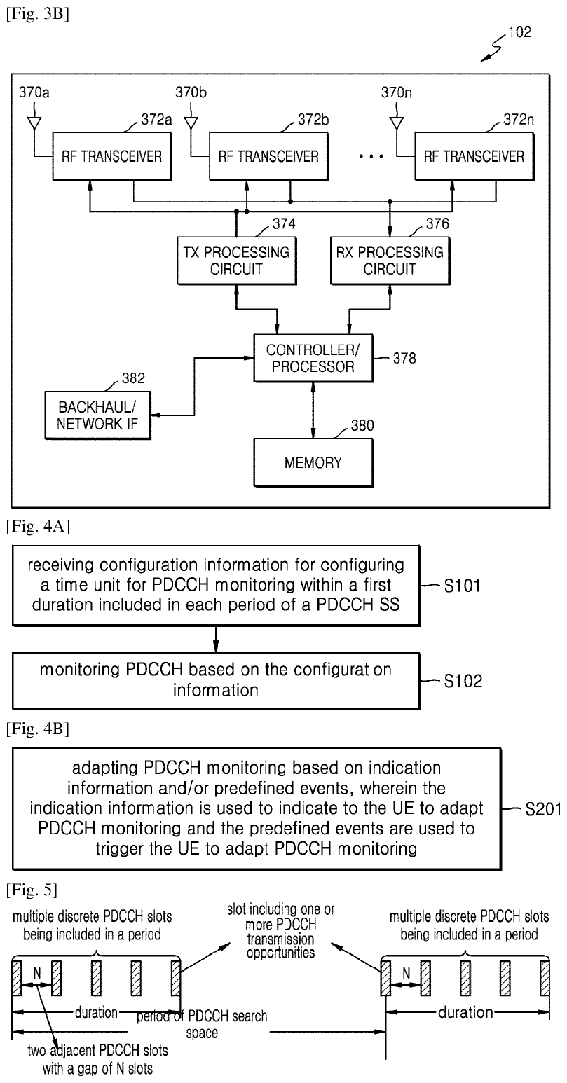

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface (IF) 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of commands, such as the BIS algorithm, are stored in the memory. The plurality of commands are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

In 4G communication systems, power saving techniques are generally implemented through high layer or MAC layer protocols. For example, a classic power saving technique is the Discontinuous Reception (DRX) mechanism, where DRX is the MAC layer controlling the UE to perform intermittent downlink reception. In the DRX configuration of the RRC connected state, the UE switches between active time and non-active time based on the control of multiple DRX timers, the UE needs to monitor PDCCH during the active time and can stop monitoring PDCCH within the non-active time; in the DRX configuration of the RRC idle state, the UE periodically monitors PDCCH for scheduling paging messages.

In 5G communication systems, in addition to DRX technology, many power saving techniques have been introduced in the physical layer. For example, 3GPP RANI has Working Item (WI) specifically for power saving. In the Rel-16 standard, the Search Space Group (SSG, which can also be called SS Group) switching technology has been introduced in the physical layer, i.e. the UE can switch between different SSGs, and Wake-Up Signal (WUS) for the DRX-on-Duration (DRX duration) of the RRC connection state, i.e. WUS is used before each DRX-on-Duration period to indicate to the UE whether or not to start monitoring during this DRX period, and a sleeping downlink carrier bandwidth part (BWP) technique is also introduced, i.e. the UE can stay on the sleeping BWP for a long time without backing onto the default BWP. In the Rel-17 standard, the Paging Early Indication (PEI) technique, i.e. the technique indicating to the UE via PEI whether to monitor PDCCH for scheduling paging messages before the Paging Occasion (PO), is discussed in the physical layer, and the power saving technique of PDCCH skipping, i.e. the technique indicating to the UE via the physical layer Downlink Control Information (DCI) to skip monitoring PDCCH for a duration, is also discussed in the physical layer.

Most of the existing power saving techniques achieve power saving by reducing the overall time for the UE to monitor PDCCH, but these power saving techniques are applicable to periodic services with definite arrival time, but not to quasi-periodic services with jitter, the so-called jitter means that the actual arrival time of the service in each period is not fixed and has jitter in a range. For this kind of services, more dynamic adaptive PDCCH monitoring is needed, for which the method for monitoring PDCCH, the electronic device and the computer-readable storage medium provided in this application embodiment give the relevant technical solutions.

A method for monitoring PDCCH for a UE is provided in this application embodiment, as shown in FIG. 4A, the method including:

Step S101: receiving configuration information for configuring a time unit for PDCCH monitoring within a first duration included in each period of a PDCCH SS;

Step S102: monitoring PDCCH based on the configuration information.

In this application embodiment, the time unit may be a discontinuous time unit, e.g. a discontinuous slot, the discontinuous slot may also be understood as a discrete slots.

In this application embodiment, the time unit for PDCCH monitoring may be a slot for monitoring PDCCH, and for ease of description, the slot for monitoring PDCCH may be referred to hereinafter as the PDCCH slot.

In this application embodiment, PDCCH SS (Search Space) may also be referred to as SS (Search Space). In some scenarios, SS or search space also refers to SS Set (SSS, Search Space Set), and the same section below will not be repeated.

In this application embodiment, a search space configuration that includes discontinuous PDCCH slot in each period is used, i.e. the UE receives a high layer configuration of the PDCCH search space that supports the inclusion of multiple discrete PDCCH slots within a period, i.e. the UE may monitor PDCCH on multiple discrete slots in each period of the PDCCH search space. Where one or more PDCCH monitoring opportunities can be available within each slot.

In practice, IE (Information Element) SearchSpace defines how and where to search for PDCCH candidates. That is, in NR system, the frequency domain location of PDCCH is configured through Control Resource Set (CORESET), which indicates the specific location of PDCCH in the frequency domain, such as the starting Physical Resource Block (PRB), the number of PRBs included, etc. In addition, CORESET indicates the number of OFDM (Orthogonal Frequency Division Multiplexing) symbols that the PDCCH includes in the time domain, and the PDCCH can be configured to occupy 1, 2 or 3 consecutive OFDM symbols. That is, CORESET indicates a time-frequency resource block on which the UE receives its own PDCCH by blind decoding multiple candidate PDCCHs, among which the UE may or may not have its own PDCCH, hence the term PDCCH monitoring. The time-frequency resource block indicated by CORESET corresponds to one PDCCH monitoring, i.e. to one PDCCH transmission opportunity. Each search space is associated with a CORESET.

The time domain location of the PDCCH (i.e. on which slot and on which symbols to monitor PDCCH) is configured via the PDCCH search space. The parameter monitoringSlotPeriodicity AndOffset included in the configuration message for the PDCCH search space is used to indicate the monitoring period of PDCCH and the location of the PDCCH slot within each period. Using this PDCCH slot as the starting slot, the number of consecutive PDCCH slots in each period is indicated by the parameter duration, and the starting symbol location of CORESET within the PDCCH slot is indicated by the parameter monitoringSymbols WithinSlot. A slot includes 14 symbols, and the number of consecutive symbols included in a CORESET is 1˜3, so a slot can include multiple CORESETs, i.e., monitoringSymbolsWithinSlot can indicate the starting symbol locations of multiple CORESETs within a slot. Based on the above configuration, it can be seen that PDCCH monitoring on a search space has periodicity and that within each period the UE can monitor PDCCH on multiple consecutive slots, as well as one or more PDCCH monitoring opportunities within each slot.
monitoringSlotPeriodicity AndOffset CHOICE {
sl1 NULL,
sl2 INTEGER (0 . . . 1),
sl4 INTEGER (0 . . . 3),
sl5 INTEGER (0 . . . 4),
sl8 INTEGER (0 . . . 7),
sl10 INTEGER (0 . . . 9),
sl16 INTEGER (0 . . . 15),
sl20 INTEGER (0 . . . 19),
sl40 INTEGER (0 . . . 39),
sl80 INTEGER (0 . . . 79),
sl160 INTEGER (0 . . . 159),
sl320 INTEGER (0 . . . 319),
sl640 INTEGER (0 . . . 639),
sl1280 INTEGER (0 . . . 1279),
sl2560 INTEGER (0 . . . 2559)
} OPTIONAL, --Cond Setup
duration INTEGER (2 . . . 2559)
OPTIONAL, --Need R
monitoringSymbols WithinSlot BIT STRING (SIZE (14))

However, for periodic services with jittered arrival times, the above configuration may not be applicable. Since the arrival time of the service is uncertain in each period, the duration indicating the number of consecutive PDCCH slots in each PDCCH monitoring period can only be configured to the length of the jitter span, and the UE needs to monitor PDCCH on each slot in the jitter span, while the network may only schedule the UE on The network may only schedule the UE on one or a few of these slots, and this consecutive slot PDCCH monitoring is a huge waste of UE power.

In this application embodiment, the UE monitors PDCCH on discrete slots within each period of the PDCCH search space, which allows for a good compromise between UE power consumption and transmission latency.

Specifically, to achieve the effect of a configuration that monitors PDCCH on discontinuous slots within the first duration included in each period of the PDCCH SS, an additional parameter can be introduced into the existing PDCCH search space configuration to determine the location of discontinuous slots (i.e. multiple PDCCH discrete slots).

In an alternative implementation, the discontinuous slots may have equal gap between them, i.e. the gap of any two adjacent PDCCH slots is the same, then the location of the discrete PDCCH slot can be determined by the periodic gap. That is, the above configuration information includes gap information indicating the gap of discontinuous time units for PDCCH monitoring within the first duration included in each period of the PDCCH SS. For example, an additional parameter interval is introduced into the existing PDCCH search space configuration information to indicate the gap between adjacent PDCCH slots within a period.

In this application embodiment, the indicated value of interval is a positive integer in units of slot. As an example, assuming that the indicated value of interval is N, then the gap between PDCCH slots is N slots, in other words, one PDCCH slot for every N+1 slots. Assuming that the starting PDCCH slot location within a period determined according to the parameter monitoringSlotPeriodicity AndOffset is n, then the PDCCH slot locations that the UE can monitor in that period are n, n+ (N+1), n+2*(N+1), n+3*(N+1), etc.

In this application embodiment, the range of the first duration can be obtained based on the existing parameter duration. The parameter duration can be understood as a slot span [n˜n+D−1] starting from the starting slot location n, where D is the indicated value of duration, i.e. the location of the PDCCH slot determined by the UE according to the gap N does not exceed this span determined by duration. For example, as shown in FIG. 5, a duration span in each period of a PDCCH search space includes 5 discrete PDCCH slots, where two adjacent PDCCH slots are separated by N slots. Alternatively, the parameter duration may be understood as the number of discrete PDCCH slots within a period, i.e. the total number of discrete PDCCH slots determined by the UE based on the gap N does not exceed the indicated value of duration.

In this application embodiment, whether or not the interval is configured is alternative. If the interval is not configured, then it indicates that the existing configuration of consecutive PDCCH slots is followed, and if the interval is configured, then it indicates that two adjacent PDCCH slots have a gap of size interval slots between them, i.e. the PDCCH slots are discontinuous.

Alternatively, the indicated value of interval may be 0 or a positive integer. If the indicated value of interval is 0, then there is no gap between PDCCH slots, i.e. the existing configuration of contiguous PDCCH slots is followed, and if the indicated value of interval is a positive integer, then there is gap between PDCCH slots, i.e. the PDCCH slots are discontinuous.

In another alternative implementation, there may be no regularity in the gap between such discontinuous slots, then the location of the discrete PDCCH slot may be indicated via Bit Map. The above configuration information may then include information indicating the location of a time unit for PDCCH monitoring within a period, which indicating the location of a time unit for PDCCH monitoring in L consecutive time units within a first duration included in each period of the PDCCH SS via a bit map of L bits, wherein L is a positive integer. For example, an additional parameter monitoringSlotsWithinPeriod is introduced into the existing PDCCH search space configuration information to indicate the location of discrete PDCCH slots within a period, where moinitoringSlots WithinPeriod may include a bit map of L bits, which is used to indicate the location of the PDCCH slots within L consecutive slots.

Optionally, a bit-indicated value of “1” indicates that the corresponding slot is a PDCCH slot, and a bit-indicated value of “0” indicates that the corresponding slot is not a PDCCH slot.

Optionally, for configuration flexibility, the length (L) of the bit map can have multiple candidate values for the base station to choose on its own.

Optionally, the bit map may be repetitive, specifically, the bit map repeats for a first duration included in each period of the PDCCH SS, i.e. once every L slots.

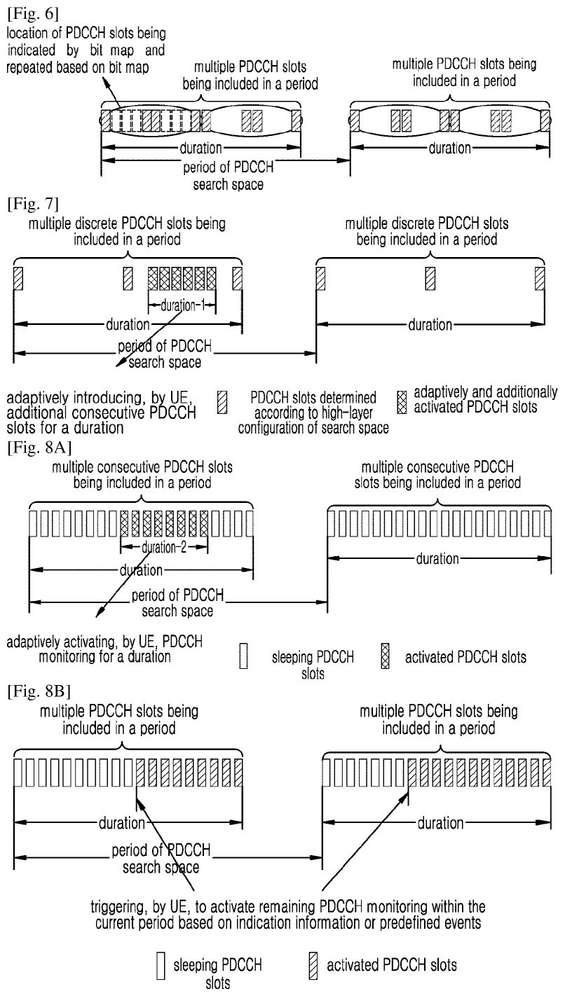

As shown in FIG. 6, the UE can determine the location of the PDCCH slot within a period based on a periodic bit map.

In this application embodiment, the range of the first duration can be obtained based on the existing parameter duration. The parameter duration can be understood as a slot span [n˜n+D−1] starting from the starting slot location n, where D is the indicated value of duration and the location of the PDCCH slot determined by the UE according to the bit map does not exceed this gap. D can be divisible by the bit map length L, i.e. the span determined by D can include one or more complete bit maps. D can also not be divisible by the bit map length L, i.e. the gap determined by D may contain one or more complete bit maps as well as an incomplete bit map. Alternatively, the parameter duration can be understood as the number of discrete PDCCH slots within a period, i.e. the total number of PDCCH slots determined by the UE according to the bit map does not exceed the indicated value of duration.

As shown in FIG. 6, the PDCCH search space includes 8 discrete PDCCH slots within the duration span of each period, where the location of the PDCCH slot is determined by a bit map of 10 slots in length.

In this application embodiment, in order to better support the flexibility of the PDCCH search space configuration, the existing parameter monitoringSymbolsWithinSlot can be extended from one slot to multiple slots, i.e. it can indicate the starting symbol location of CORESET within multiple slots. For example, the extended monitoringSymbolsWithinSlot indicates the starting symbol location of CORESET in 4 slots. A slot includes 14 symbols, so the extended monitoringSymbolsWithinSlot includes 56 bits, and one bit corresponds to one OFDM symbol. The indicated value of “1” means that the corresponding symbol is the start location of CORESET. In actual configuration, the base station should avoid the configuration of a CORESET across two slots.

For this application embodiment, the granularity of the indicated value of the configuration parameter duration for the above PDCCH search space is also extended to 4 slots. For example, if the indicated value of the parameter duration is 4, then it means that the search space includes 16 consecutive slots in each period, where the CORESET locations within each of the 4 slot are the same, which is determined by the parameter monitoringSymbolsWithinSlot.

In order to save the above monitoringSymbolsWithinSlot signalling overhead, the starting symbol location of CORESET can be fixed at a specific location. For example, assuming that CORESET includes 3 symbols, then the start location of CORESET can only be the 1st, 4th, 7th and 11th symbols in a slot, i.e. CORESET has only 4 possible starting locations in a slot, then the 14 bits of a slot in the original bit map can be reduced to 4 bits, thus achieving a reduction in signalling overhead.

A method for monitoring PDCCH for a UE is provided in this application embodiment, as shown in FIG. 4B, the method includes:

Step S201: adapting PDCCH monitoring based on indication information and/or predefined events, wherein the indication information is used to indicate to the UE to adapt PDCCH monitoring and the predefined events are used to trigger the UE to adapt PDCCH monitoring.

In this application embodiment, the step of adapting PDCCH monitoring can specifically include dynamically adjusting the PDCCH monitoring or adaptively adjusting the PDCCH monitoring.

wherein the step of adapting PDCCH monitoring includes at least one of the following.

Option I: activating additional PDCCH monitoring of a first PDCCH SS on consecutive time units for a second duration.

Option 2: activating PDCCH monitoring of a second PDCCH SS for a third duration.

Option 3: skipping remaining PDCCH monitoring of a third PDCCH SS within the current period.

Option 4: skipping PDCCH monitoring of a fourth PDCCH SS for a fourth duration.

Option 5: activating remaining PDCCH monitoring of a sixth PDCCH SS within the current period.

Option 6: starting or skipping PDCCH monitoring of a fifth PDCCH SS within a period.

In this application embodiment, the time unit for PDCCH monitoring may be a slot for monitoring PDCCH, and for ease of description, the slot for monitoring PDCCH may be referred to hereinafter as the PDCCH slot.

In this application embodiment, options I, II and VI can be understood as the UE adaptively starting PDCCH monitoring.

Considering that in the existing standards, the slot on which the UE monitors PDCCH are pre-configured by the high layer, i.e. the PDCCH monitoring is semi-static and does not change for a duration, but the semi-static PDCCH monitoring is not applicable to dynamic service changes. For example, the base station provides data scheduling for service Y on PDCCH search space X for a UE, and for service Y, a large packet arrives at a location where the PDCCH monitoring of one period of search space X is about to end. Since the packet is large, it needs to be segmented into multiple transmission blocks for transmission, and since the PDCCH monitoring of that period is about to end, part of the transmission blocks of service Y may no longer be able to be scheduled through search space X. Although the base station can schedule service Y on other search spaces, the configuration of the search space generally has correspondence with the application layer service when the base station is implemented, so taking up the scheduling resources of other search spaces will bring congestion to the scheduling of other search spaces. If the base station can notify the UE to activate PDCCH monitoring on consecutive slots for a duration on search space X, then the base station can continue to use search space X to schedule the remaining data of service Y.

In the present disclosure embodiment, the UE is better able to adapt to dynamic service changes by adaptively starting PDCCH monitoring.

In this application embodiment, option III can be understood as the UE adaptively skipping (skip) the remaining PDCCH monitoring in a particular search space within a period.

Considering that in the existing standard, for a PDCCH search space, the UE has to start PDCCH monitoring in every period and needs to complete PDCCH monitoring on all pre-configured PDCCH slots, unless the UE is in the non-active time of DRX (non-active time).

In this application embodiment, the UE may skip the remaining PDCCH monitoring within the current period for the purpose of power saving, for example, if only one packet arrives within a period and the arriving packet has already been transmitted.

In this application embodiment, option IV can be understood as the UE adaptively skipping PDCCH monitoring for a duration for the purpose of power saving.

For embodiments of the present disclosure, the step of at least one of the following may also be included.
determining the length of a second duration, a third duration or a fourth duration based on the indication of at least one of the received RRC signalling, MAC CE and DCI, wherein the indication granularity of the length of the second duration, the third duration or the fourth duration is a slot;
determining, based on the indication of the received RRC signalling, a plurality of candidate values for the length of the second duration, the third duration or the fourth duration, and determining one of the plurality of candidate values as the length of the second duration, the third duration or the fourth duration based on the received indication of at least one of MAC CE and DCI;
determining the identification number ID of the first PDCCH SS, the second PDCCH SS, the third PDCCH SS, the fourth PDCCH SS, or the sixth PDCCH SS based on the received indication of at least one of RRC signalling, MAC CE and DCI;
determining a PDCCH SS transmitting MAC CE as the first PDCCH SS, the third PDCCH SS, or the fourth PDCCH SS;
determining a PDCCH SS transmitting DCI as the first PDCCH SS, the third PDCCH SS, or the fourth PDCCH SS, wherein the MAC CE and/or DCI includes information to indicate adaptation of PDCCH monitoring.

Wherein the first PDCCH SS, the second PDCCH SS, the third PDCCH SS, the fourth PDCCH SS, the fifth PDCCH SS, or the sixth PDCCH SS includes at least one of the following:
a PDCCH SS;
a group of PDCCH SSs;
all USSs;
all USSs and Type 3 CSSs;
all USSs and all CSSs.

The method for monitoring PDCCH provided by this application embodiment enables the reduction of the number of PDCCH monitoring, thereby achieving power saving for the UE.

In embodiments of the present disclosure, feasible implementations are specifically provided for options I, II and VI corresponding to step S201.

For option I, PDCCH monitoring of a first PDCCH SS (e.g. one or a group of (multiple) PDCCH SSs) consecutive slots is additionally activated for a second duration, i.e. the UE adaptively starts PDCCH monitoring of the first PDCCH SS on a range (second duration) of consecutive slots that are independent of the PDCCH slot determined by the high layer configuration parameters of the first PDCCH SS, i.e. this range of consecutive PDCCH slots is independent of the group of PDCCH slots determined by the high layer configuration parameters of the first PDCCH SS parameters, i.e. this consecutive PDCCH slots may partially overlap or not overlap at all with the PDCCH slot determined according to the high layer configuration parameters of the first PDCCH SS, the UE monitors consecutive PDCCH slots for a duration on the first PDCCH SS, and these consecutive PDCCH slots is additionally activated for the first PDCCH SS.

As shown in FIG. 7, the PDCCH SS includes 3 discrete PDCCH slots in each period. At a moment the UE triggers a range of PDCCH monitoring on 6 consecutive slots (i.e. the second duration, corresponding to duration-1 in FIG. 7) based on received commands or predefined events, i.e. this PDCCH SS adaptively and newly adds 6 consecutive PDCCH slots during this period. The locations of these 6 additional PDCCH slots can change dynamically, and the locations of the 3 discrete PDCCH slots already available are pre-configured based on the high layer configuration parameters of the search space. The methods for determining the locations of these two PDCCH slots are different, but the PDCCH monitoring on these two PDCCH slots are the same, both monitoring the same PDCCH SS. This means that the location of the symbols within the monitoring slot, the monitoring CORESET, the monitoring DCI format, etc. are all the same.

FIG. 7 is only a simple example and the available solutions are not limited to it. Suitable variations based on this example may also be applied to this application and should also be included within the scope of protection of this application. The location of the adaptively and additionally activated PDCCH slots is restricted to the duration span. Alternatively, the location of the adaptively and additionally activated PDCCH slots can be outside the duration span. In addition, adaptively and additionally activated PDCCH slots are limited to one period. Alternatively, adaptively and additionally activated PDCCH slots can span two periods.

For option II, PDCCH monitoring of a second PDCCH SS (e.g. one or a group of PDCCH SSs) is activated for a third duration, i.e. the UE adaptively activates PDCCH monitoring of the second PDCCH SS for a duration (i.e. a third duration). Wherein the second PDCCH SS or the sixth PDCCH SS includes a PDCCH SS that is configured to be in a sleeping mode (or referred to as a sleeping state) via RRC signalling, i.e. for the present disclosure embodiment it is a prerequisite that the second PDCCH SS or the sixth PDCCH SS is configured as a sleeping state. Sleeping it is meant that the UE does not need to perform PDCCH monitoring for this or this group of PDCCH SS, and the PDCCH slots in the sleeping state can be referred to as sleeping PDCCH slots. In an example, after the second PDCCH SS or the sixth PDCCH SS has been configured to a sleeping state via high layer signalling, the base station adaptively indicated to the UE to activate this second PDCCH SS or the sixth PDCCH SS based on service changes. For example, the second PDCCH SS or the sixth PDCCH SS may be activated via MAC CE or DCI. Being activated it is meant that the UE needs to perform PDCCH monitoring on this second PDCCH SS or sixth PDCCH SS and the UE returns to the sleeping state after the activated state persists for a duration (e.g. a third duration or the remaining duration within the current period) in which the PDCCH slot during this activated time may be referred to as an activated PDCCH slot.

As shown in FIG. 8A, a PDCCH SS is configured to be sleeping and the UE does not need to monitor this PDCCH SS. At a moment, the UE activates this PDCCH SS based on a received command or a predefined event and persists for a duration (e.g. third duration, corresponding to duration-2 in FIG. 8A) and the UE needs to monitor this PDCCH SS on the PDCCH slot during the activated time.

As shown in FIG. 8B, a PDCCH SS is configured to be sleeping and the UE does not need to monitor this PDCCH SS. At a moment, the UE activates the remaining PDCCH monitoring of this PDCCH SS within the current period based on received commands or predefined events, i.e. the UE needs to monitor remaining PDCCH slots of the current period, and in the next period of the PDCCH SS, the PDCCH SS goes back to sleeping again, if the UE does not receive an indication information or no predefined event occurs during one period of the PDCCH SS, then the UE does not need to monitor PDCCH for the whole period of the PDCCH SS.

In this application embodiment, the location of the activated PDCCH slot is pre-configured, i.e. determined by the high layer configuration parameters of the search space.

For options I and II in this application embodiment, the PDCCH monitoring of the UE can be activated adaptively according to the dynamic changes of the service, but there is a fundamental difference between the two, the PDCCH monitoring activated in option I is based on the adaptively and additionally activated PDCCH slots, the PDCCH monitoring activated in options II or VI is to activate the configured PDCCH slots.

In embodiments of the present disclosure, the length of the second duration or the third duration is determined based on the indication of at least one of the received RRC signaling, MAC CE, DCI, and an activation signal, wherein the indication granularity of the length of the second duration or the third duration is the slot, wherein the MAC CE, the DCI, and/or the activation signal includes information for adapting PDCCH monitoring. In the case of option II, for example, the indication granularity of the activated time length may be a slot. The activated time length is expressed by the number of consecutive slots. Both the number of these consecutive slots and the number of consecutive PDCCH slots additionally activated in option I can be configured by the base station, for example, the exact value of the number of consecutive slots can be configured by RRC signalling.

Alternatively, based on the indication of the received RRC signalling, a plurality of candidate values for the length of the second duration or the third duration is determined, and based on the indication of at least one of the received MAC CE, the DCI, and an activation signal, one of the plurality of candidate values is determined as the length of the second duration or the third duration, wherein the MAC CE, the DCI, and/or the activation signal includes information for adapting PDCCH monitoring. For example, multiple candidate values for the number of consecutive slots are configured via RRC signalling and one of these values is further indicated as the actually used number of consecutive slots via MAC CE or DCI. Other embodiments of how the activation signal is implemented are described below.

In this application embodiment, the first PDCCH SS, the second PDCCH SS or the sixth PDCCH SS includes at least one of the following: a PDCCH SS and a group of PDCCH SSs. That is, the PDCCH monitoring started in option I, option II or option VI is for one or a group of search spaces and the UE does not need to start PDCCH monitoring for all PDCCH search spaces. In other embodiments, the first PDCCH SS, the second PDCCH SS or the sixth PDCCH SS may also include other embodiments, such as all USSs, all USSs and Type 3 CSSs, or all USSs and all CSSs, etc.

In embodiments of the present disclosure, the ID of the first PDCCH SS, the second PDCCH SS, or the sixth PDCCH SS may be determined based on the indication of at least one of the received RRC signaling, MAC CE, and DCI. For example, the ID of the SS or SSG that starts PDCCH monitoring in option I, option II or option VI is configured via RRC signalling; or, the ID of the SS or SSG that starts PDCCH monitoring in option I, option II or option VI is indicated via MAC CE or DCI. Optionally, the MAC CE or DCI directly indicates the ID of the SS or SSG, or the MAC CE or DCI includes a bit map indication field corresponding to multiple SSs or SSGs, with an indicated value of “1” indicating that PDCCH monitoring on the corresponding SS or SSG is started, and an indicated value of “0” means that PDCCH monitoring on the corresponding SS or SSG is not started.

In this application embodiment, the ID of the SS or SSG that starts PDCCH monitoring in options I and II can be determined by implicit means, i.e. without indication by signalling. For example, taking option I as an example, assuming that the starting of PDCCH monitoring in option I is indicated by MAC CE or DCI, then the PDCCH SS transmitting MAC CE is determined as the first PDCCH SS, where MAC CE includes information for adapting PDCCH monitoring; or, the PDCCH SS transmitting DCI is determined as the first PDCCH SS, where DCI includes information for adapting PDCCH monitoring. That is, the SS used to transmit this MAC CE or DCI command defaults to be the SS applying this command, and the PDCCH monitoring on other SSs does not change; or, the SSG including the SS used to transmit this MAC CE or DCI command defaults to be the SSG applying this command, and the PDCCH monitoring on other SSG does not change.

Optionally, in this application embodiment, adaptively started PDCCH monitoring in option I, option II or option VI needs to comply with the existing DRX mechanism, i.e., adaptively started PDCCH monitoring essentially provides the UE with the opportunity to monitor PDCCH, but whether the UE will actually monitor PDCCH is also dependent on the DRX control. For example, if the UE is configured with all DRX timers not running, or if the UE receives a MAC CE carrying DRX control signalling such that the UE enters the non-active time of DRX, then the UE needs to stop all PDCCH monitoring on this serving cell, including adaptively started PDCCH monitoring. That is, within the non-active time of DRX, the UE does not need to perform the adaptively started PDCCH monitoring in options I, II or VI.

Optionally, in this application embodiment, since the purpose of adaptively started PDCCH monitoring is to match dynamic changes of service traffic, then such PDCCH monitoring may not need to comply with the existing DRX mechanism, i.e. the additionally activated PDCCH monitoring of the first PDCCH SS on consecutive time units in the second duration is also to be executed within the non-active time of DRX; and/or, activating PDCCH monitoring of the second PDCCH SS for a third duration is also to be executed within the non-active time of DRX and/or, activating the remaining PDCCH monitoring of the sixth PDCCH SS within the current period is also to be executed within the non-active time of DRX. This means that the UE needs to actually monitor PDCCH of the corresponding search space on the corresponding slot, regardless of whether the DRX state is active or non-active. For example, if the UE is configured so that all DRX timers are not running, or the UE receives a MAC CE carrying DRX control signalling such that the UE will enter a non-active time, then the UE needs to stop all PDCCH monitoring on this serving cell, excluding this adaptively started PDCCH monitoring. That is, within the non-active time of DRX, the UE also needs to perform the adaptively started PDCCH monitoring in options I and II.

In this application embodiment, step S201 may specifically include: based on the indication of at least one of the received MAC CE, DCI, and an activation signal, activating additional PDCCH monitoring of the first PDCCH SS on consecutive time units for a second duration (corresponding to option I), activating PDCCH monitoring of the second PDCCH SS for a third duration (corresponding to option II), or activating the remaining PDCCH monitoring of the sixth PDCCH SS within the current period (corresponding to option VI), where the activation signal is carried by a physical signal sequence. For example, the base station indicates to the UE via MAC CE or DCI to activate a new PDCCH monitoring on one or a group of search spaces on consecutive slots (corresponding to option I), or indicates to the UE to activate the PDCCH monitoring on one or a group of search spaces for a duration (corresponding to option II), or to activate the remaining PDCCH monitoring of the sixth PDCCH SS within the current period (corresponding to option VI). If starting PDCCH monitoring is indicated via MAC CE, then the UE may start to start PDCCH monitoring after a predefined number of slots after the HARQ feedback of this MAC CE. If starting PDCCH monitoring is indicated via DCI, then the UE may start to start PDCCH monitoring after a predefined number of slots after this DCI. Other embodiments of how the activation signal is implemented are described below.

To save signalling overhead, it is also possible to trigger the UE to newly add starting a new PDCCH monitoring on one or a group of search spaces on consecutive slots via a predefined event (corresponding to option I) or indicate to the UE to activate starting the PDCCH monitoring on one or a group of search spaces for a duration (corresponding to option II).

In this application embodiment, step S201 may specifically include: activating additional PDCCH monitoring of the first PDCCH SS on consecutive time units for a second duration if a DCI for scheduling new transmission is received on the first PDCCH SS. For example, if the UE receives a DCI for scheduling new transmission on a specific SS or SSG, then the UE starts PDCCH monitoring on this SS or SSG for option I, where the ID of the specific SS or SSG is predefined or pre-configured. The UE can start PDCCH monitoring for option I after scheduling a predefined number of slots after the DCI for scheduling new transmission.

In an embodiment of the present disclosure, step S201 may specifically include: activating additional PDCCH monitoring of the first PDCCH SS on consecutive time units for a second duration, if a DCI for scheduling new transmission is received on the first PDCCH SS and the DCI includes at least one of the following: a DCI that scrambles CRC with a predefined RNTI value; a DCI uses a predefined DCI format; a DCI includes information indicating predefined service characteristic; and the TBS scheduled by the DCI is greater than at least one of a predefined threshold. For example, if the UE receives a DCI for scheduling new transmission on a particular SS or SSG and the DCI scrambles the CRC with a particular RNTI value, and/or uses a particular DCI format, and/or includes information indicating predefined service characteristic, and/or the TBS scheduled by the DCI is greater than a certain threshold, then the UE starts PDCCH monitoring on this SS or SSG for option I, wherein the ID of the particular SS or SSG, the particular RNTI, and the particular DCI format is predefined or preconfigured.

In this application embodiment, step S201 may specifically include: activating additional PDCCH monitoring of the first PDCCH SS associated with an SR on consecutive time units for a second duration after transmitting the SR, or activating PDCCH monitoring of the second PDCCH SS associated with the SR within a third duration after transmitting the SR, or activating the remaining PDCCH monitoring of the sixth PDCCH SS associated with the SR within the current period after transmitting the SR, if the SR is transmitted. For example, if the UE transmits a specific SR, then the UE will start the PDCCH monitoring for option I or option II or option VI, where the specific SR is specifically configured. The ID of the SS or SSG associated with this SR is pre-configured. For example, the UE starts the PDCCH monitoring for option I, option II or option VI after a predefined number of slots after transmitting the SR, i.e. starts the PDCCH monitoring on the SS or SSG associated with that SR.

In this application embodiment, step S201 may specifically include: activating additional PDCCH monitoring of the first PDCCH SS associated with a PUSCH on consecutive time units for a second duration after transmitting the PUSCH, activating PDCCH monitoring of the second PDCCH SS associated with the PUSCH for a third duration after transmitting the PUSCH, or activating the remaining PDCCH monitoring of the sixth PDCCH SS associated with the PUSCH within the current period after transmitting the PUSCH, if the configured grant PUSCH is transmitted. For example, if the UE transmits a configured grant PUSCH, then the UE will start the PDCCH monitoring for option I, option II or option VI, where the ID of the SS or SSG associated with this configured grant PUSCH is pre-configured. For example, the UE starts the PDCCH monitoring for option I, option II or option VI after a predefined number of slots after transmitting the preconfigured scheduled PUSCH, i.e., starts the PDCCH monitoring on the SS or SSG associated with this preconfigured scheduled PUSCH.

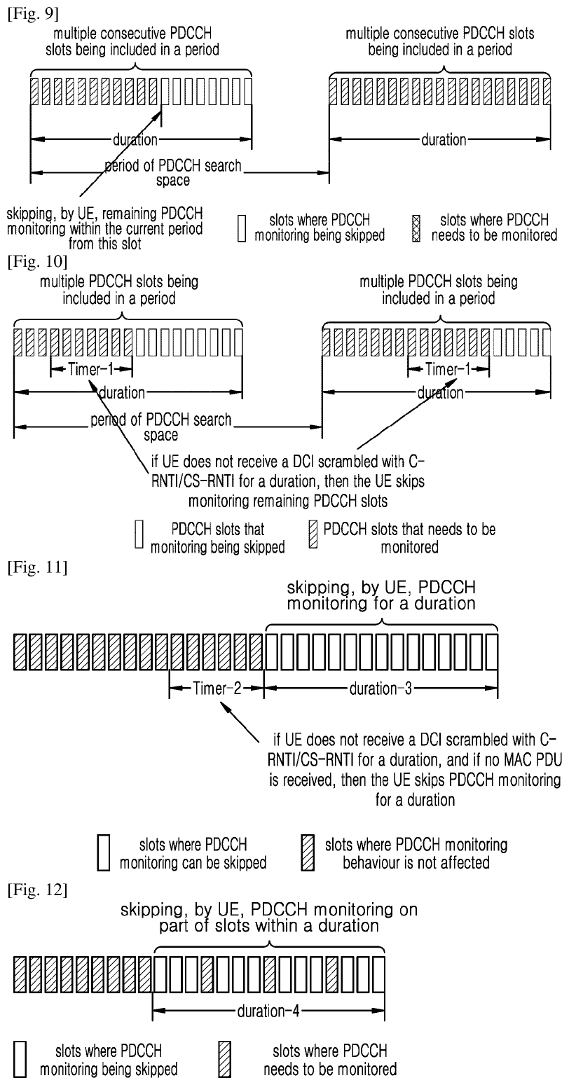

In this application embodiment, a feasible implementation is provided for option III corresponding to step S201, specifically, skipping remaining PDCCH monitoring of the third PDCCH SS (e.g. one or a group of PDCCH SSs) within the current period, i.e., the UE adaptively skips the remaining PDCCH monitoring of the third PDCCH SS within the current period until starting again the PDCCH monitoring of the third PDCCH SS within the next period. By skipping remaining PDCCH monitoring means that the UE does not need to monitor the third PDCCH SS from one moment until the end of the Duration span of the current period. As shown in FIG. 9, at a moment, for a PDCCH SS, the UE triggers skipping of the remaining PDCCH monitoring based on a received command or a predefined event, and the UE does not start the PDCCH monitoring until the next period. The UE behaviour of skipping PDCCH monitoring is triggered adaptively, i.e., the start location of skipping PDCCH monitoring is dynamically changed.

In this application embodiment, the third PDCCH SS includes at least one of the following: a PDCCH SS and a group of PDCCH SSs. That is, skipping remaining PDCCH monitoring in option III is for one or a group of search spaces, the UE cannot skip all remaining PDCCH monitoring of all PDCCH search spaces within the current period. In other embodiments, the third PDCCH SS may also include other cases, such as all USSs, all USSs and Type 3 CSSs, or all USSs and all CSSs, etc.

In embodiments of the present disclosure, the ID of the third PDCCH SS may be determined based on the indication of at least one of the received RRC signalling, MAC CE and DCI. For example, the ID of the SS or SSG that skips the remaining PDCCH monitoring in option III is configured by RRC signalling. Or, the ID of the SS or SSG that skips the remaining PDCCH monitoring in option III is indicated by MAC CE or DCI. For example, the MAC CE or DCI directly indicates the ID of the SS or SSG, or the MAC CE or DCI includes a bit map indication field corresponding to multiple SSs or SSGs, and an indicated value of “1” indicates that the remaining PDCCH monitoring on the corresponding SS or SSG within the current period is skipped, and an indicated value of “O” indicates that the remaining PDCCH monitoring on the corresponding SS or SSG within the current period needs to be executed.

In this application embodiment, the ID of the SS or SSG that skips the remaining PDCCH monitoring in option III can be determined by implicit means, i.e., without indication by signalling. For example, assuming that skipping remaining PDCCH monitoring in Embodiment 4 is indicated by the MAC CE or DCI, then the PDCCH SS transmitting the MAC CE is determined as the third PDCCH SS, where the MAC CE includes information for adapting PDCCH monitoring; or, the PDCCH SS transmitting the DCI is determined as the third PDCCH SS, where the DCI includes information for adapting PDCCH monitoring. That is, the SS used to transmit this MAC CE or DCI command defaults to the SS to which the skip command is applied, and the PDCCH monitoring on other SSs does not change; or, the SSG to which the SS used to transmit this MAC CE or DCI command belongs defaults to the SSG to which the skip command is applied, and the PDCCH monitoring on SSs other than this SSG does not change.

In this application embodiment, step S201 may specifically include: skipping remaining PDCCH monitoring of the third PDCCH SS within the current period based on the indication of the received MAC CE or DCI. For example, the base station indicates to the UE via DCI or MAC CE to skip all the remaining PDCCH opportunities of one or a group of search spaces within the current period. If indicated via MAC CE to skip the remaining PDCCH monitoring, then the UE may start skipping PDCCH monitoring after a predefined number of slots after the HARQ feedback of this MAC CE. If indicated via DCI to skip the remaining PDCCH monitoring, then the UE may start skipping PDCCH monitoring after a predefined number of slots after this DCI.

In this application embodiment, the UE adaptively skipping remaining PDCCH monitoring of one or a group of PDCCH search space(s) within the current period may be event-based triggered. In one possible implementation, step S201 may specifically include: skipping remaining PDCCH monitoring of the third PDCCH SS within the current period if the scheduling DCI on the third PDCCH SS is not received for the sixth duration. For example, as shown in FIG. 10, if the UE does not receive any scheduling on a PDCCH search space for a duration (Timer), then the UE skips the remaining PDCCH monitoring of this search space within the current period, where the length of the duration (i.e., the sixth duration) is pre-configured by the base station.

In this application embodiment, the UE can control the skip behaviour via a timer, i.e., the length of the sixth duration is configured via a first timer, and if the first timer stops running, it starts skipping remaining PDCCH monitoring of the third PDCCH SS within the current period at the first time unit after the first timer stops running. Wherein the first timer is started at the start location of the third PDCCH SS within each period; if the DCI with C-RNTI or CS-RNTI scrambled CRC is received on the third PDCCH SS, the first timer is started or re-started. For example, the base station preconfigures a timer (i.e., a first timer) RemainingPDCCHSkipping-InactivityTimer for the PDCCH search space and the UE starts the RemainingPDCCHSkipping-Inactivity Timer at the start location of each period of the search space, whenever the UE receives a DCI scrambled with C-RNTI or CS-RNTI on this search space, then it starts or re-starts the RemainingPDCCHSkipping-Inactivity Timer, and once the timer RemainingPDCCHSkipping-InactivityTimer stops running, the UE then starts skipping PDCCH monitoring at the first slot afterwards until the end of the Duration span of the current period.

In this application embodiment, a feasible implementation is provided for option IV corresponding to step S201, specifically: step S201 may specifically include: skipping PDCCH monitoring of the fourth PDCCH SS for the fourth duration if the scheduling DCI on the fourth PDCCH SS is not received for the seventh duration, i.e., the UE is triggered by an implicit method to skip a duration of PDCCH monitoring.

PDCCH skip is a power saving technique under discussion in the current power saving work item of the 3GPP RANI Rel-17 standard. The PDCCH skip discussed in the Rel-17 standard is indicated by the base station via DCI. In contrast, the UE is triggered to skip a duration of PDCCH monitoring by an implicit method in this application embodiment, which saves signalling overhead.

In this application embodiment, if the UE does not receive any data transmission for a duration (i.e., the seventh duration). For example, as shown in FIG. 11, the UE does not receive any scheduling DCI scrambled with C-RNTI or CS-RNTI for a duration (corresponding to timer-2 in FIG. 11), and does not receive any MAC PDUs (i.e., does not receive pre-configured resources on the physical data channel), then the UE skips the PDCCH monitoring for a duration (i.e. the fourth duration, corresponding to duration-3 in FIG. 11).

In this application embodiment, the UE can control the skip behaviour via a timer, i.e. the length of the seventh duration is configured via a second timer, and if the second timer stops running, the PDCCH monitoring of the fourth PDCCH SS for the fourth duration starts to be skipped at the first time unit after the second timer stops running; wherein, if the DCI with C-RNTI or CS-RNTI scrambled CRC is received on the fourth PDCCH SS, the second timer is started or re-started. For example, the base station pre-configures the timer (i.e., the second timer) PDCCHSkipping-Inactivity Timer for the UE and whenever the UE receives a DCI scrambled with C-RNTI or CS-RNTI, or whenever the UE receives a MAC PDU, then the UE starts or re-starts the PDCCHSkipping-InactivityTimer and as soon as the timer PDCCHSkipping-Inactivity Timer stops running, the UE starts skipping PDCCH monitoring at the first slot afterwards and continues for duration-3 (i.e. the fourth duration).

In this application embodiment, skipping PDCCH monitoring of the fourth PDCCH SS for the fourth duration may specifically comprise: skipping PDCCH monitoring of the fourth PDCCH SS on part of the time units for the fourth duration.

In the current 3GPP RANI Rel-17 standard power saving technology, PDCCH skip is a power saving technology under discussion, the PDCCH skip discussed in the Rel-17 standard refers to skip PDCCH monitoring on all slots for a duration. If a packet arrives suddenly during this period, then the packet can only be scheduled after the end of the PDCCH skip, which will inevitably increase the transmission delay. However, in the present application embodiment, the UE is able to skip PDCCH monitoring on some of the slots for a duration, which is a good compromise between power saving and transmission delay.

As shown in FIG. 12, the UE skips PDCCH monitoring on some of the slots in the duration-4 (i.e. for the fourth duration) span, while it needs to keep PDCCH monitoring on the other slots.

In this application embodiment, step S201 may specifically include: skipping PDCCH monitoring of the fourth PDCCH SS for the fourth duration based on the indication of the received MAC CE or DCI.

In this application embodiment, step S201 may specifically include: skipping PDCCH monitoring of the fourth PDCCH SS on part of the time units for the fourth duration based on the indication of the received MAC CE or DCI. That is, the base station indicates to the UE via MAC CE or DCI to skip PDCCH monitoring on part of the slots for a duration (duration-4).

Optionally, in this application embodiment, there is a certain regularity for the location of the part of time units (slot) within duration-4 where PDCCH monitoring is skipped. For example, the time unit (slot) location for skipping PDCCH monitoring has the equal gap characteristic, i.e. for the fourth duration, the PDCCH monitoring on one time unit are skipped every N consecutive time units and the PDCCH monitoring on the other time units are reserved; or, the slot location for keeping PDCCH monitoring has the equal gap characteristic, i.e. the PDCCH monitoring on a slot is reserved every N consecutive slots in the fourth duration, the PDCCH monitoring on the other time units is reserved, and the PDCCH monitoring on the other time units is skipped. Where N is a positive integer greater than 1 and the value of N may be configured by RRC signalling; or, alternatively, a plurality of values of N may be configured by RRC signalling, with a further indication of one of the plurality of values in the MAC CE or DCI carrying the skip command.

Optionally, in this application embodiment, the location of the part of slots within duration-4 where PDCCH monitoring is skipped is indicated by a bit map, for example, the number of bits included in the bit map is the number of slots included in duration-4, each bit corresponds to a slot, and an indicated value of “1” means that the UE skips or keeps the PDCCH monitoring for the corresponding slot, and a value of “0” indicates that the PDCCH monitoring for the corresponding slot is kept or skipped; or, the number of bits included in the bit map is less than the number of slots included in duration-4, and similar to the previous section, the location of the skipped PDCCH monitoring is determined based on the repetition of the bit map in the duration-4 span.

The fourth PDCCH SS in this application embodiment includes at least one of the following: all USSs, all USSs and Type 3 CSSs, all USSs and all CSSs, etc. That is, the UE skipping PDCCH monitoring means that the UE skips all PDCCH monitoring on USS for a duration (i.e. the fourth duration) and PDCCH monitoring on CSS is not affected; or, the UE skipping PDCCH monitoring for a duration means that the UE skips PDCCH monitoring on all USSs as well as Type (type) 3 CSSs for a duration and PDCCH monitoring on other type CSS are not affected; or, UE skipping PDCCH monitoring for a duration means that the UE skips PDCCH monitoring on all SSs including USS and CSS. In other embodiments, the fourth PDCCH SS may also include other situations, such as a PDCCH SS, a group of PDCCH SSs, etc.

In embodiments of the present disclosure, the length of the fourth duration may be determined based on the indication of at least one of the received RRC signaling, MAC CE and DCI, wherein the indication granularity of the length of the fourth duration is a slot, wherein the MAC CE and/or the DCI includes information for adapting PDCCH monitoring.

Alternatively, based on the indication of the received RRC signaling, a plurality of candidate values for the length of the fourth duration is determined, and based on the indication of at least one of the received MAC CE and DCI, one of the plurality of candidate values is determined as the length of the fourth duration, wherein the MAC CE, DCI, and/or activation signal includes information for adapting PDCCH monitoring.

That is, in this application embodiment, the indication granularity of the length (duration-3 or duration-4) of a duration (i.e. the fourth duration) for skipping PDCCH monitoring may be a slot, i.e. expressed by the number of consecutive slots for a duration, wherein number of consecutive slots may be configured by the base station, for example, the specific values of duration-3 and duration-4 can be configured by RRC signalling; or, multiple candidate values of duration-3 and duration-4 can be configured by RRC signalling and one of these values can be further indicated as the actually used duration-3 and duration-4 by MAC CE or DCI.

In embodiments of the present disclosure, the identification number ID of the fourth PDCCH SS may be determined based on the indication of at least one of the received RRC signaling, MAC CE and DCI; or the identification number ID of the fourth PDCCH SS may be determined by an implicit method, such as determining the PDCCH SS transmitting MAC CE as the fourth PDCCH SS, wherein the MAC CE includes information for adapting PDCCH monitoring; or, the PDCCH SS transmitting DCI is determined as the fourth PDCCH SS, wherein the DCI includes information for adapting PDCCH monitoring. The details of the implementation can be found in a similar presentation above and will not be repeated here.

In this application embodiment, the above-mentioned activation signal is described. Optionally, the activation signal may be in the form of a WUS for indicating whether to start the PDCCH monitoring, or, alternatively, the activation signal may also be in the form of other signals, and the application embodiment does not specifically limit the form of the activation signal here.

Considering that in the existing standard, the UE has to start PDCCH monitoring at the beginning of each period of the PDCCH search space, this behaviour is actually more power consuming, for non-periodic services, there may be no packets arriving in many periods, and for periodic services, there may also be no packets arriving in a certain period. In this application embodiment, the base station is able to, based on the actual status of whether packets arrive to inform the UE whether to start PDCCH monitoring, so that the UE power consumption will be significantly reduced.

The following description is based on the example of the activation signal being WUS. It should be understood by those skilled in the art that a description based on this is not to be construed as limiting the activation signal.

In this application embodiment, step S201 may specifically include: starting or skipping PDCCH monitoring of the fifth PDCCH SS within a period based on the indication of at least one of the received MAC CE, DCI and activation signal, wherein the activation signal is carried by a physical signal sequence.

For this application embodiment, the DCI or activation signal is associated with a duration of the fifth PDCCH SS, wherein the gap between the time domain location of the DCI or activation signal and the start location of its corresponding period is predefined or preconfigured by RRC signalling; and/or the gap between the start location and/or the end location of the monitoring span of the DCI or activation signal and the start location of its corresponding period is predefined or pre-configured by RRC signalling.

The following is an example of starting or skipping PDCCH monitoring of the fifth PDCCH SS within a period based on the indication of the received activation signal.

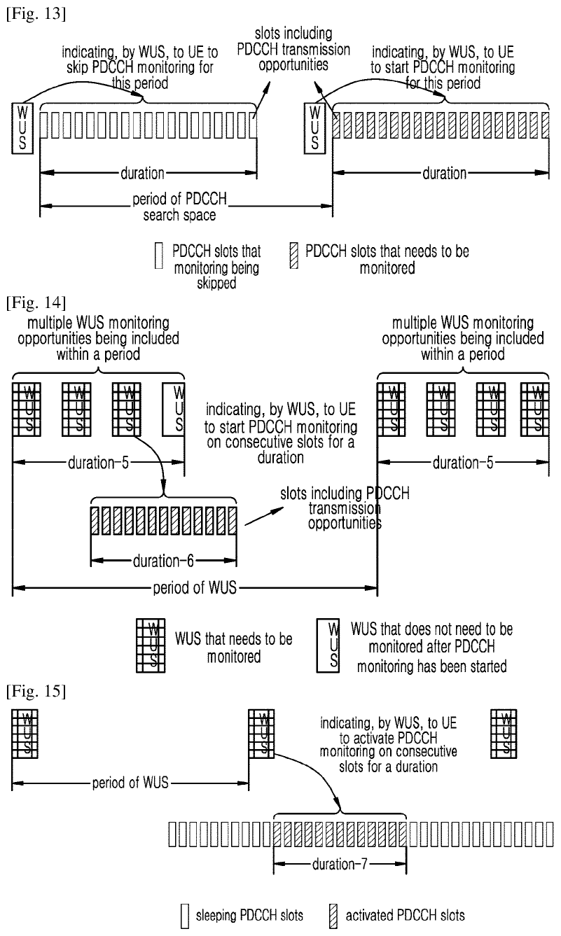

For example, a PDCCH search space of the UE is associated with a WUS and the UE monitors associated WUS before each period of the PDCCH search space (i.e. the associated fifth PDCCH SS) and then decides whether to start PDCCH monitoring for the corresponding period based on the monitoring result of the WUS. Optionally, the WUS associated with the search space is used to indicate whether the UE starts PDCCH monitoring for this search space within a period. As shown in FIG. 13, the WUS may indicate the UE to skip PDCCH monitoring for the corresponding period or to indicate the UE to start PDCCH monitoring for the corresponding period.

Wherein the time domain location of the WUS can be determined by the start location of the PDCCH search space at each period. For example, each period of the PDCCH search space corresponds to a WUS, and the gap between the WUS and the corresponding first PDCCH slot may be predefined or pre-configured. For example, the gap between the WUS and the time domain location of the corresponding first PDCCH slot can be pre-configured by the base station via RRC signalling.

In this application embodiment, the WUS associated with each period of the PDCCH search space is suitable for services where the packet arrival time is deterministic, and for services where the packet arrival time is jittering, the UE can monitor WUS on multiple moments within a period due to the uncertainty of the packet arrival time in each period, and after the packet arrives, the base station can indicate the UE to start PDCCH monitoring on consecutive slots via the nearest WUS, which is a good compromise between transmission delay and UE power saving.

In other embodiments, the PDCCH monitoring of the fifth PDCCH SS within a period may also be started or skipped based on the indication of the received MAC CE and/or DCI, as may be similarly described above and will not be repeated here.

In particular, the activation signal may be monitored in at least one of the following ways:
periodically monitoring the activation signal;
monitoring the activation signal at multiple time domain locations within a fifth duration included in each period of the activation signal.

Specifically, the step of monitoring the activation signal at multiple time domain locations within a fifth duration included in each period of the activation signal: skipping monitoring the activation signal at other time domain locations following the time domain location where the activation signal is monitored within the same period if the activation signal is monitored at one time domain location.

In this application embodiment, WUS is used to indicate whether the UE starts PDCCH monitoring of a specific search space on consecutive slots (duration-5) (e.g. it may correspond to option I above, then duration-5 may correspond to duration-1 above) and the WUS configuration is similar to the PDCCH search space. For example, WUS monitoring is periodic and includes multiple WUS monitoring opportunities within a duration (duration-6) in each period. The multiple WUS monitoring opportunities included within duration-6 can be located in either consecutive or discrete slots, and if the WUS slot are discrete, the location of the WUS slot within the duration can be configured using the equal gap feature or bit map method described above. In each period, there is at most one opportunity out of multiple WUS monitoring opportunities to indicate to the UE to start PDCCH monitoring on consecutive slots. That is, if the UE has monitored a WUS indicating that the UE starts PDCCH monitoring on consecutive slots, then the remaining WUS slots within the current period need not be monitored, and if the UE has not monitored a WUS indicating that the UE starts PDCCH monitoring on consecutive slots, then the UE needs to continue monitoring the WUS, as shown in FIG. 14. Where duration-6 can be configured similarly to the PDCCH search space via RRC signalling.

In this application embodiment, if the WUS indicates to the UE to start PDCCH monitoring on consecutive slots for a duration (duration-5), then the UE starts the PDCCH monitoring at the first slot after the predefined gap after the WUS.

In this application embodiment, WUS is used to indicate to the UE to activate PDCCH monitoring on a specific search space for a duration (duration-7) (e.g. it may correspond to option II above, then duration-7 may correspond to duration-2 above). Similarly, as shown in FIG. 15, the WUS may be periodic, i.e. the UE monitors WUS periodically and if the WUS indicates to the UE to activate PDCCH monitoring for a duration, then the UE starts the PDCCH monitoring at the first slot after the predefined gap after the WUS.

As shown in FIG. 15, similar to the activation of PDCCH monitoring within a consecutive time in option II, a SS or SSG is configured to be sleeping and the UE periodically monitors WUS associated with this SS or SSG, the WUS may indicate to the UE to activate PDCCH monitoring for a duration. Activation it is meant that the UE needs to perform PDCCH monitoring on this SS or SSG. The UE returns to the sleeping state after a duration of activation. The PDCCH slot during this activation period can be referred to as the activated PDCCH slot, where the location of the PDCCH slot is determined by the high layer pre-configured parameters of the search space, i.e. the activated pre-configured PDCCH slot.

In this application embodiment, the indication granularity of the length of a duration for starting PDCCH monitoring (duration-5 or duration-7, which may also correspond to the second duration or third duration described above) may be a slot, i.e. expressed by the number of consecutive slots for a duration, wherein number of consecutive slots for a duration may be configured by the base station, for example, the specific values of duration-5 and duration-7 may be configured by RRC signalling, or, alternatively, multiple candidate values of duration-5 and duration-7 may be configured by RRC signalling, and one of these values can be further indicated in the WUS signalling as the actually used duration-5 and duration-7.

In the present disclosure embodiment, the UE detects the activation signal (e.g. WUS) on a determined block of time-frequency resources, which effectively saves UE power compared to the blind decoding of the PDCCH.

In this application embodiment, the activation signal is carried by at least one of the following: a physical signal sequence, a DCI transmitted to one UE, and a DCI transmitted to a group of UEs.

For example, WUS can be carried by physical signal sequences, and energy detection based on physical signal sequences can further save UE power compared to coherent detection by PDCCH. The base station can indicate whether PDCCH monitoring is started based on whether the WUS transmits an implicit indication. For example, if the UE does not detect a WUS, then the PDCCH monitoring is skipped; if the UE does detect a WUS, then the PDCCH monitoring is started.

Alternatively, the WUS can be carried by DCI. For example, if the DCI includes 1 bit, a value of “1” indicates that the UE needs to start PDCCH monitoring, while a value of “O” indicates that the UE skips PDCCH monitoring. To save system signalling overhead, the WUS can be carried by a UE-group DCI, i.e. a DCI includes the WUS of several UEs. This DCI is monitored by a group of UEs, each UE finds its own indication information from the received DCI. The starting location in the UE-group DCI of the WUS indication field of each UE can be configured by the base station via RRC signalling.

In this application embodiment, the WUS may be for a PDCCH search space, i.e. the PDCCH monitoring on a PDCCH search space is adaptively adjusted by the WUS.

In fact, the base station can configure up to 10 PDCCH search spaces per carrier BWP for the UE. If the UE is configured with a larger number of PDCCH search spaces, considering each PDCCH search space being configured with a WUS, a lot of system resources will be consumed. In order to avoid a large number of WUSs, in this application embodiment, the WUS is for a group of PDCCH search spaces, i.e. PDCCH monitoring on a group of PDCCH search spaces can be adaptively adjusted by the WUS.

Further, in this application embodiment, the WUS may be for a BWP, i.e. the PDCCH monitoring on all or predefined search spaces on a BWP is adaptively adjusted by the WUS.

Optionally, the DCI in each of the above embodiments may include at least one of the following:
DCI for scheduling data;
dedicated DCI indicating power saving commands;
dedicated DCI for a UE;
dedicated DCI for a group of UEs.

Wherein, if the DCI is dedicated DCI for a group of UEs, the starting location in the DCI of the information bit used to indicate to the UE to adapt PDCCH monitoring is indicated via RRC signalling.

Also provided in this application embodiment is a method for monitoring PDCCH for a base station, the method includes:

Step S301: transmitting an indication information for adapting a PDCCH monitoring behaviour to a UE, to cause the UE to perform a corresponding PDCCH monitoring behaviour based on the indication information, wherein the indication information is used to indicate to the UE to adapt PDCCH monitoring behaviour.

Similarly, the detailed functional descriptions of the methods of the embodiments of the present disclosure corresponding to the methods of the UE-side embodiments and the resulting beneficial effects can be found specifically in the descriptions of the corresponding methods shown for the UE-side embodiments in the preceding text and will not be repeated here.

Embodiments of the present disclosure provide an electronic device, specifically, but not exclusively, a UE, which may specifically include a receiving module and a PDCCH monitoring module, wherein,
the receiving module is configured to receive configuration information for configuring a time unit for PDCCH monitoring within a first duration included in each period of a PDCCH SS;
the PDCCH monitoring module is configured to monitor PDCCH based on the configuration information.

In an alternative embodiment, the configuration information includes at least one of the following:
gap information indicating the gap of discontinuous time units for PDCCH monitoring within the first duration included in each period of the PDCCH SS;
information indicating the location of a time unit for PDCCH monitoring within a period, which indicating the location of a time unit for PDCCH monitoring in L consecutive time units within a first duration included in each period of the PDCCH SS via a bit map of L bits, wherein L is a positive integer.

Embodiments of the present disclosure provide an electronic device, specifically, but not exclusively, a UE, which may specifically include an adaptation module, wherein,
the adaptation module is configured to adapt PDCCH monitoring based on indication information and/or predefined events, wherein the indication information is used to indicate to the UE to adapt PDCCH monitoring and the predefined events are used to trigger the UE to adapt PDCCH monitoring.

In an alternative embodiment, the adaptation module is specifically used for at least one of the following:
activating additional PDCCH monitoring of a first PDCCH SS on consecutive time units for a second duration;
activating PDCCH monitoring of a second PDCCH SS for a third duration;
skipping remaining PDCCH monitoring of a third PDCCH SS within the current period;
skipping PDCCH monitoring of a fourth PDCCH SS for a fourth duration;
activating remaining PDCCH monitoring of a sixth PDCCH SS within the current period.

In an alternative implementation, the second PDCCH SS and/or the sixth PDCCH SS include a PDCCH SS configured to be in a sleeping mode via RRC signalling.

In an alternative embodiment, the adaptation module is specifically used for at least one of the following:
based on the indication of at least one of the received MAC CE, DCI, and activation signal, activating additional PDCCH monitoring of the first PDCCH SS on consecutive time units for a second duration, activating PDCCH monitoring of the second PDCCH SS for a third duration, or activating remaining PDCCH monitoring of the sixth PDCCH SS associated with a SR within the current period after transmitting the SR, wherein the activation signal is carried by a physical signal sequence.
activating additional PDCCH monitoring of the first PDCCH SS on consecutive time units for a second duration if a DCI for scheduling new transmission is received on the first PDCCH SS;
activating additional PDCCH monitoring of the first PDCCH SS on consecutive time units for a second duration, if a DCI for scheduling new transmission is received on the first PDCCH SS and the DCI includes at least one of the following: a DCI that scrambles CRC with a predefined RNTI value; a DCI uses a predefined DCI format; a DCI includes information indicating predefined service characteristic; and the TBS scheduled by the DCI is greater than at least one of a predefined threshold;
if a SR is transmitted, activating additional PDCCH monitoring of the first PDCCH SS associated with the SR on consecutive time units for a second duration after transmitting the SR, or activating PDCCH monitoring of the second PDCCH SS associated with the SR within a third duration after transmitting the SR, or activating remaining PDCCH monitoring of the sixth PDCCH SS associated with the SR after transmitting the SR within the current period;
if a configured grant PUSCH is transmitted, activating additional PDCCH monitoring of the first PDCCH SS associated with the PUSCH on consecutive time units for a second duration after the PUSCH is transmitted, or activating PDCCH monitoring of the second PDCCH SS associated with the PUSCH for a third duration after the PUSCH is transmitted, or activating remaining PDCCH monitoring of the sixth PDCCH SS associated with the PUSCH within the current period.

In an alternative embodiment, the adaptation module is further configured to monitor the activation signal by at least one of the following means:
periodically monitoring the activation signal;
monitoring the activation signal at multiple time domain locations within a fifth duration included in each period of the activation signal.

In an alternative implementation, the adaptation module, when is specifically used to monitor the activation signal at multiple time domain locations within a fifth duration included in each period of the activation signal, is specifically configured to:

monitor activation signals at other time domain locations after a time domain location where an activation signal was monitored within a period is skipped, if the activation signal is monitored at the time domain location.

In an alternative implementation, the step of activating additional PDCCH monitoring of the first PDCCH SS on consecutive time units for the second duration is also to be performed within a non-active time of DRX; and/or
the step of activating PDCCH monitoring of the second PDCCH SS for a third duration is also to be performed within the non-active time of DRX; and/or
the step of activating remaining PDCCH monitoring of the sixth PDCCH SS within the current period is also to be performed within the non-active time of DRX.

In an alternative embodiment, the adaptation module is specifically used for at least one of the following:
skipping remaining PDCCH monitoring of the third PDCCH SS within the current period based on the indication of the received MAC CE or DCI;
skipping remaining PDCCH monitoring of the third PDCCH SS within the current period if no scheduling DCI is received on the third PDCCH SS for the sixth duration.

In an alternative implementation, the length of the sixth duration is configured via a first timer, and if the first timer stops running, the remaining PDCCH monitoring of the third PDCCH SS within the current period is skipped starting at a first time unit after the first timer stops running.

wherein the first timer is started at the start location of each period of the third PDCCH SS.

If a DCI with C-RNTI or CS-RNTI scrambled CRC is received on the third PDCCH SS, the first timer is started or restarted.

In an alternative embodiment, the adaptation module is specifically used for at least one of the following:
skipping PDCCH monitoring of the fourth PDCCH SS for a fourth duration if no scheduling DCI is received on the fourth PDCCH SS for the seventh duration;
skipping PDCCH monitoring of the fourth PDCCH SS for a fourth duration based on the indication of the received MAC CE or DCI.

In an alternative implementation, the length of the seventh duration is configured via a second timer, and if the second timer stops running, the PDCCH monitoring of the fourth PDCCH SS for the fourth duration is skipped starting at a first time unit after the second timer stops running.

Wherein the second timer is started or restarted if a DCI with C-RNTI or CS-RNTI scrambled CRC is received is received on the fourth PDCCH SS.

In an alternative implementation, the adaptation module is specifically configured to skip PDCCH monitoring of the fourth PDCCH SS on part of the time units for the fourth duration.

In an alternative implementation, the adaptation module is specifically configured to skip PDCCH monitoring on one time unit every N consecutive time units for the fourth duration and PDCCH monitoring on the other time units is reserved; or
reserving PDCCH monitoring on one time unit every N consecutive time units for the fourth duration, and PDCCH monitoring on the other time units is reserved.

Where N is a positive integer.

In an alternative embodiment, the electronic device further includes a determination module, wherein the determination module is used for at least one of the following:
determining the length of a second duration, a third duration or a fourth duration based on the indication of at least one of the received RRC signalling, MAC CE and DCI, wherein the indication granularity of the length of the second duration, the third duration or the fourth duration is a slot;
determining, based on the indication of the received RRC signalling, a plurality of candidate values for the length of the second duration, the third duration or the fourth duration, determining one of the plurality of candidate values as the length of the second duration, the third duration or the fourth duration based on the indication of at least one of the received MAC CE and DCI;
determining the identification number ID of the first PDCCH SS, the second PDCCH SS, the third PDCCH SS, the fourth PDCCH SS, or the sixth PDCCH SS based on the indication of at least one of the received RRC signalling, MAC CE and DCI;
determining a PDCCH SS transmitting MAC CE as the first PDCCH SS, the third PDCCH SS, or the fourth PDCCH SS;
determining a PDCCH SS transmitting DCI as the first PDCCH SS, the third PDCCH SS, or the fourth PDCCH SS,
where the MAC CE and/or DCI includes information to indicate adaptation of PDCCH monitoring.

In an alternative implementation, the adaptation module is specifically used for: starting or skipping PDCCH monitoring of the fifth PDCCH SS within a period based on the indication of at least one of the received MAC CE, DCI and activation signal, wherein the activation signal is carried by a physical signal sequence.

In an alternative implementation, the DCI or activation signal is associated with one period of the fifth PDCCH SS, wherein
the gap between the time domain location of the DCI or activation signal and the start location of its corresponding period is predefined or pre-configured by RRC signalling; and/or
the gap between the start and/or end location of the monitoring span of the DCI or activation signal and the start location of its corresponding period is predefined or pre-configured by RRC signalling.

In an alternative embodiment, the first PDCCH SS, the second PDCCH SS, the third PDCCH SS, the fourth PDCCH SS, the fifth PDCCH SS, or the sixth PDCCH SS, includes at least one of the following:
a PDCCH SS;
a group of PDCCH SSs;
all USSs;
all USSs and Type 3 CSSs;
all USSs and all CSSs.

In an alternative embodiment, the DCI includes at least one of the following:
DCI for scheduling data;
dedicated DCI indicating power saving commands;
dedicated DCI for a UE;
dedicated DCI for a group of UEs.

In an alternative implementation, if the DCI is a UE-group specific DCI, the starting location in the DCI of the information bit used to indicate to the UE to adapt PDCCH monitoring is indicated by RRC signalling.

Embodiments of the present disclosure further provide an electronic device, specifically, but not exclusively, a base station, which may include a transmission module, wherein the transmission module is configured to transmit indication information and/or configuration information to a UE to cause the UE to perform a corresponding PDCCH monitoring behaviour based on the indication information and/or configuration information, wherein the indication information is used to indicate to the UE to adapt PDCCH monitoring and the configuration information is used to configure a time unit for PDCCH monitoring within a first duration included in each period of a PDCCH SS.

The electronic device of an embodiment of the present application can execute the method provided by the embodiment of the present application, and the implementation principles thereof are similar. The actions executed by various modules in the electronic device of various embodiments of the present application correspond to the steps in the method of various embodiments of the present application. For a detailed functional description of various modules of the electronic device and the advantages brought about thereby, reference can be made in particular to the description of the corresponding method shown in the preceding text, and thus the detailed description thereof will not be repeated here.

Provided in embodiments of the present disclosure is an electronic device including: a transceiver; and a processor, coupled to the transceiver and configured to perform to implement the steps of each of the preceding method embodiments. Optionally, the electronic device may be a UE, the processor in the electronic device being configured to perform controls to implement the steps of the method for monitoring PDCCH for the UE as provided in the preceding method embodiments. Optionally, the electronic device may be a base station, the processor in the electronic device being configured to perform controls to implement the steps of the method for monitoring PDCCH for the base station as provided in the preceding method embodiments.

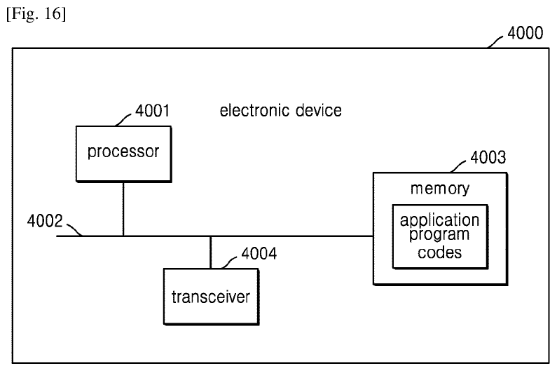

In an alternative embodiment an electronic device is provided, as shown in FIG. 16, the electronic device 1600 shown in FIG. 16 includes: a processor 1601 and a memory 1603. where the processor 1601 and the memory 1603 are connected, e.g. via a bus 1602. Optionally, the electronic device 1600 may further include a transceiver 1604, which may be used for data interaction between this electronic device and other electronic devices, such as the transmitting of data and/or the receiving of data, etc. It is to be noted that the transceiver 1604 is not limited to one in practical applications and the structure of this electronic device 1600 does not constitute a limitation to the embodiments of this application.

The processor 1601 may be a central processing unit (CPU), a general-purpose processor, a digital signal processor (DSP), an application specific integrated circuit (ASIC), and an field programmable gate array (FPGA), or other programmable logic device, transistor logic device, hardware component, or any combination thereof. It is possible to implement or execute the various exemplary logical blocks, modules and circuits described in combination with the disclosures of the present disclosure. The processor 1601 may also be a combination of computing functions, such as a combination of one or more microprocessor, a combination of a DSP and a microprocessor, and so on.

The bus 1602 can include a path for delivering information among the above components. The bus 1602 may be a peripheral component interconnect (PCI) bus or an extended industry standard architecture (EISA) bus. The bus 1602 may be divided into an address bus, a data bus, a control bus, and so on. For case of illustration, only one bold line is shown in FIG. 16, but does not indicate that there is only one bus or type of bus.

The memory 1603 may be a read only memory (ROM) or other types of static storage devices that can store static information and instructions, a random access memory (RAM) or other types of storage devices that can store information and instructions. The memory 4003 may also be electrically erasable programmable read only memory (EEPROM), compact disc read only memory (CD-ROM) or other optical disk storage, optical disk storage (including compressed compact disc, laser disc, compact disc, digital versatile disc, blue-ray disc, etc.), magnetic disk storage medium or other magnetic storage device, or any other medium capable of carrying or storing computer programs and capable of being accessed by a computer, but not limited to this.

The memory 1603 is used to store computer programs for executing embodiments of the present application and is controlled for execution by the processor 1601. The processor 1601 is used to execute the computer program stored in the memory 1603 to implement the steps shown in the preceding method embodiment.

Embodiments of the present application provide a computer-readable storage medium having a computer program stored on the computer-readable storage medium, the computer program, when executed by a processor, implements the steps and corresponding contents of the foregoing method embodiments.

Embodiments of the present application also provide a computer program product including a computer program, the computer program when executed by a processor realizing the steps and corresponding contents of the preceding method embodiments.

The terms “first”, “second”, “third”, “fourth”, “1”, “2”, and the like in the description and in the claims of the present application and in the preceding figures, are used for distinguishing between similar objects and not necessarily for describing a particular sequential or chronological order. It is to be understood that the data so used are interchangeable under appropriate circumstances such that the embodiments of the disclosure-described herein are capable of operation in other sequences than described or illustrated herein.

It should be understood that, although various operational steps are indicated by arrows in the flowcharts of embodiments of the present application, the order in which the steps are performed is not limited to the order indicated by the arrows. Unless explicitly stated herein, in some implementation scenarios of embodiments of the present disclosure, the implementation steps in the respective flowcharts may be performed in other order as required. In addition, some or all of the steps in each flowchart may include multiple sub-steps or multiple stages based on the actual implementation scenario. Some or all of these sub-steps or stages may be executed at the same time, or each of these sub-steps or stages may be executed separately at different times. The order of execution of these sub-steps or stages can be flexibly configured according to requirements in different scenarios of execution time, and the embodiments of the present application are not limited thereto.

The above-mentioned description is merely an alternative embodiment for some implementation scenarios of the present application, and it should be noted that it would have been within the scope of protection of embodiments of the present application for those skilled in the art to adopt other similar implementation means based on the technical idea of the present application without departing from the technical concept of the solution of the present application.

1. A method for monitoring Physical Downlink Control Channel (PDCCH) for a User Equipment (UE), comprising:
receiving configuration information for configuring a time unit for PDCCH monitoring within a first duration included in each period of a PDCCH Search Space (SS);
monitoring PDCCH based on the configuration information.

2. The method of claim 1, wherein, the configuration information comprises at least one of the following:
gap information indicating the gap of discontinuous time units for PDCCH monitoring within the first duration included in each period of the PDCCH SS;
information indicating the location of a time unit for PDCCH monitoring within a period, which indicating the location of a time unit for PDCCH monitoring in L consecutive time units within a first duration included in each period of the PDCCH SS via a bit map of L bits, wherein L is a positive integer.

3. A method for monitoring Physical Downlink Control Channel (PDCCH) for a User Equipment (UE), comprising:
adapting PDCCH monitoring based on indication information and/or predefined events, wherein the indication information is used to indicate to the UE to adapt PDCCH monitoring and the predefined events are used to trigger the UE to adapt PDCCH monitoring;
wherein the adapting PDCCH monitoring comprises at least one of the following:
activating additional PDCCH monitoring of a first PDCCH SS on consecutive time units for a second duration;
activating PDCCH monitoring of a second PDCCH SS for a third duration;
skipping remaining PDCCH monitoring of a third PDCCH SS within the current period;
skipping PDCCH monitoring of a fourth PDCCH SS for a fourth duration;
activating remaining PDCCH monitoring of a sixth PDCCH SS within the current period.

4. The method of claim 3, wherein, the second PDCCH SS or sixth PDCCH SS comprises a PDCCH SS configured to be in a sleeping mode via radio resource control (RRC) signaling.

5. The method of claim 3, wherein, the activating additional PDCCH monitoring of a first PDCCH SS on consecutive time units for a second duration, activating PDCCH monitoring of a second PDCCH SS for a third duration, or activating remaining PDCCH monitoring of a sixth PDCCH SS within the current period based on indication information and/or predefined events comprises at least one of the following:
activating additional PDCCH monitoring of the first PDCCH SS on consecutive time units for the second duration, activating PDCCH monitoring of the second PDCCH SS for the third duration, activating the remaining PDCCH monitoring of the sixth PDCCH SS within the current period based on the indication of at least one of the received control element of media access control layer (MAC CE), downlink control information (DCI), and an activation signal, where the activation signal is carried by a physical signal sequence;
activating additional PDCCH monitoring of the first PDCCH SS on consecutive time units for the second duration if a DCI for scheduling new transmission is received on the first PDCCH SS;
activating additional PDCCH monitoring of the first PDCCH SS on consecutive time units for the second duration, if a DCI for scheduling new transmission is received on the first PDCCH SS and the DCI comprises at least one of the following: a DCI that scrambles cyclic redundancy check (CRC) with a predefined radio network temporary identity (RNTI) value; a DCI uses a predefined DCI format; a DCI includes information indicating predefined service characteristic; and the TBS scheduled by the DCI is greater than at least one of a predefined threshold;
if a scheduling request (SR) is transmitted, activating additional PDCCH monitoring of the first PDCCH SS associated with the SR on consecutive time units for the second duration after transmitting the SR, or activating PDCCH monitoring of the second PDCCH SS associated with the SR for the third duration after transmitting the SR, or activating remaining PDCCH monitoring of the sixth PDCCH SS associated with the SR after transmitting the SR within the current period;
if a configured grant PUSCH is transmitted, activating additional PDCCH monitoring of the first PDCCH SS associated with the PUSCH on consecutive time units for the second duration after the PUSCH is transmitted, or activating PDCCH monitoring of the second PDCCH SS associated with the PUSCH for the third duration after the PUSCH is transmitted, or activating remaining PDCCH monitoring of the sixth PDCCH SS associated with the PUSCH within the current period.

6. The method of claim 3, wherein, the activating additional PDCCH monitoring of the first PDCCH SS on consecutive time units for the second duration is to be performed within a non-active time of DRX; and/or
the activating PDCCH monitoring of the second PDCCH SS for a third duration is to be performed within the non-active time of DRX; and/or
the activating remaining PDCCH monitoring of the sixth PDCCH SS within the current period is to be performed within the non-active time of DRX.

7. The method of claim 3, wherein, the skipping remaining PDCCH monitoring of a third PDCCH SS within the current period based on indication information and/or predefined events comprises at least one of the following:
skipping remaining PDCCH monitoring of the third PDCCH SS within the current period based on the indication of the received MAC CE or DCI;
skipping remaining PDCCH monitoring of the third PDCCH SS within the current period if no scheduling DCI is received on the third PDCCH SS for the sixth duration.

8. The method of claim 3, wherein, the skipping PDCCH monitoring of a fourth PDCCH SS for a fourth duration based on the indication information and/or predefined events comprises at least one of the following:
skipping PDCCH monitoring of the fourth PDCCH SS for the fourth duration if no scheduling DCI is received on the fourth PDCCH SS for the seventh duration;
skipping PDCCH monitoring of the fourth PDCCH SS for the fourth duration based on the indication of the received MAC CE or DCI.

9. The method of claim 3, wherein, the skipping PDCCH monitoring of a fourth PDCCH SS for a fourth duration comprises:
skipping PDCCH monitoring of the fourth PDCCH SS on part of the time units for the fourth duration.

10. The method of claim 3, further comprising at least one of the following:
determining the length of the second duration, the third duration or the fourth duration based on the indication of at least one of the received RRC signaling, MAC CE and DCI;
determining, based on the indication of received RRC signaling, a plurality of candidate values for the length of the second duration, the third duration or the fourth duration, determining, based on the indication of at least one of received MAC CE and DCI, one of the plurality of candidate values as the length of the second duration, the third duration or the fourth duration;
determining the identification number ID of the first PDCCH SS, the second PDCCH SS, the third PDCCH SS, the fourth PDCCH SS, or the sixth PDCCH SS based on the indication of at least one of the received RRC signaling, MAC CE and DCI;
determining a PDCCH SS transmitting MAC CE as the first PDCCH SS, the third PDCCH SS, or the fourth PDCCH SS;
determining a PDCCH SS transmitting DCI as the first PDCCH SS, the third PDCCH SS, or the fourth PDCCH SS,
wherein the MAC CE and/or DCI comprises information to indicate adaptation of PDCCH monitoring.

11. The method of claim 3, wherein, the adapting PDCCH monitoring based on indication information and/or predefined events comprises:
starting or skipping PDCCH monitoring of the fifth PDCCH SS within a period based on the indication of at least one of the received MAC CE, DCI and activation signal, wherein the activation signal is carried by a physical signal sequence.

12. The method of claim 3, wherein, the first PDCCH SS, the second PDCCH SS, the third PDCCH SS, the fourth PDCCH SS, the fifth PDCCH SS, or the sixth PDCCH SS comprises at least one of the following:
a PDCCH SS;
a group of PDCCH SSs;
all UE-specific search spaces (USSs);
all USSs and Type 3 common search spaces (CSSs);
all USSs and all CSSs.

13. A method for monitoring Physical Downlink Control Channel (PDCCH) for a base station, comprising:
transmitting indication information and/or configuration information to a UE to cause the UE to perform a corresponding PDCCH monitoring behaviour based on the indication information and/or configuration information, wherein the indication information is used to indicate to the UE to adapt PDCCH monitoring and the configuration information is used to configure a time unit for PDCCH monitoring within a first duration included in each period of a PDCCH SS.

14. A user equipment (UE), comprising:
a transceiver; and
a processor coupled to the transceiver, wherein the processor configured to:
adapt PDCCH monitoring based on indication information and/or predefined events, wherein the indication information is used to indicate to the UE to adapt PDCCH monitoring and the predefined events are used to trigger the UE to adapt PDCCH monitoring;
wherein the adapting PDCCH monitoring comprises at least one of the following:
activate additional PDCCH monitoring of a first PDCCH SS on consecutive time units for a second duration;
activate PDCCH monitoring of a second PDCCH SS for a third duration;
skip remaining PDCCH monitoring of a third PDCCH SS within the current period;
skip PDCCH monitoring of a fourth PDCCH SS for a fourth duration;
activate remaining PDCCH monitoring of a sixth PDCCH SS within the current period.

15. The UE of claim 14, wherein, the second PDCCH SS or sixth PDCCH SS comprises a PDCCH SS configured to be in a sleeping mode via radio resource control (RRC) signaling.
